(19) United States
(12) Patent Application Publication
(10) Pub. No.: US 2025/0103014 A1
(43) Pub. Date: Mar. 27, 2025

(54) CONTROL SYSTEMS, APPARATUS AND TECHNIQUES UTILIZING GRAPH SYSTEMS

(71) Applicant: Enel X S.R.L., ROME (IT)

(72) Inventors: Akhilesh Bakshi, Bellevue, WA (US); Timothy E. Meehan, Pasco, WA (US); Cesar A. Silva-Monroy, Selah, WA (US)

(21) Appl. No.: 18/293,538

(22) PCT Filed: Aug. 26, 2022
(86) PCT No.: PCT/IB2022/058023

§ 371 Date: Jan. 30, 2024

Related U.S. Application Data
(60) Provisional application No. 63/238,095, filed on Aug. 27, 2021.

(51) Int. Cl. G05B 13/04

(52) U.S. Cl. CPC G05B 13/042

(57) ABSTRACT

The present disclosure is directed to systems and methods for enhancing control of a system using a graph system. A graph system is constructed comprising one or more vertices, one or more edges, and one or more graph layers. Each vertex represents an entity in the system that includes one or more attributes. Each edge represents a flow of an attribute with respect to at least one vertex (entity in the system). Each graph layer comprising one or more vertices and one or more intra-layer edges. An optimization model is constructed from the graph system. The optimization model can be optimized utilizing an optimization algorithm to identify the set of control values that optimize the optimization model. A dispatch set of control values for a set of controllable output attributes of the system is provided to the system to control operation of the system.

### RELATED APPLICATIONS

This application claims the benefit under 35 U.S.C. § 119(e) of U.S. Provisional Patent Application No. 63/238,095, titled “CONTROL SYSTEMS, APPARATUS AND TECHNIQUES UTILIZING GRAPH SYSTEMS,” filed Aug. 27, 2021, which is hereby incorporated by reference herein in its entirety.

### TECHNICAL FIELD

The present disclosure is directed to systems and methods for control of a system, and more particularly to systems and methods for enhancing control of a system using graph systems.

### BACKGROUND

Systems of interdependent entities are present everywhere. The entities (or elements) of a system can be virtually anything that can be labeled, including other systems that can connect, interact, communicate, or otherwise interrelate with another thing. Systems theory, an interdisciplinary field of study or science, is founded on an idea of the whole being greater than the sum of its parts.

Some systems are assembled or otherwise formed to perform operations or otherwise accomplish one or more purposes. For example, an electrical system may generate and/or distribute electricity to one or more loads. A plumbing system may provide water to various locations. A financial system enables or otherwise facilitates transfer or exchange of capital/funds (e.g., money, stocks, other instruments of value), such as may occur in transactions or other exchanges. A manufacturing system assembles or otherwise produces a product or good. A heating, ventilation, and air-conditioning (HVAC) system monitors and controls the temperature and humidity of human occupied (e.g., commercial building) or unoccupied (e.g., data center) premises. A hydroelectric dam is a system that generates electricity, controls water flow, and may impact fish migration, barge traffic, and/or irrigation.

Controllable elements of some embodiments of systems may influence or otherwise impact other elements of such systems and may thereby influence or otherwise impact operation of the system as a whole. An environment in which a system operates, and inputs from the environment, may influence or otherwise impact other elements of such systems and may thereby also influence or otherwise impact operation of the system.

Automatically controlling a system, such as with a controller, may be beneficial and may be desirable to enable intelligent actions to be taken to utilize controllable elements of an electrical system more effectively. Operation of a system is challenging when the structure of the system and/or the environment in which the system operates is dynamic. Optimized operation (or otherwise enhanced operation) of a system with a dynamic structure and/or environment is even more difficult.

Systems, methods, and techniques to facilitate modelling of systems and objectives of systems may be desirable to improve automated control of controllable systems.

### SUMMARY

The present disclosure is directed to optimization or otherwise enhancing operation of systems using graph systems (e.g., graph data structures). The present disclosure is directed to optimization or otherwise enhancing operation of a system with a flow by using a graph system as a model of the system.

Additional aspects and advantages will be apparent from the following detailed description of preferred embodiments, which proceeds with reference to the accompanying drawings.

### BRIEF DESCRIPTION OF THE DRAWINGS

Additional aspects and advantages will be apparent from the following detailed description of preferred embodiments, which proceeds with reference to the accompanying drawings, in which:

FIG. 1 is a block diagram illustrating a system architecture of a controllable electrical system, according to one embodiment of the present disclosure, including a controller utilizing an optimizing graph system.

FIG. 2 is a block diagram illustrating a system architecture of an optimizing graph system, according to another embodiment of the present disclosure.

FIG. 3 is diagram of a system architecture of a controller for an optimizing graph system, according to one embodiment of a present disclosure.

FIG. 4 is a relational diagram of a multi-layered graph system, according to one embodiment of the present disclosure.

FIG. 5 depicts a graph system, according to one embodiment of the present disclosure, for a site electrical system including an electrical graph layer and a financial graph layer.

FIG. 6 depicts a graph system, according to one embodiment of the present disclosure, with a diagnostic graph layer appended to the electrical graph layer and financial graph layer.

FIG. 7 is a data relationship diagram for a graph system, according to one embodiment of the present disclosure, and illustrating a data relationship in the construction of a graph layer and a data relationship to associated graph layers.

FIG. 8 is a flow diagram of a method for a controller to construct a graph system, according to one embodiment of the present disclosure, and to construct graph layers of the graph system and make associations between the graph layers.

FIG. 9 is a flow diagram of a method of a controller to construct an optimization model utilizing a graph system, according to one embodiment of the present disclosure.

FIG. 10 is a method for a graph system for associating modeling blocks to elements of the graph system, according to one embodiment of the present disclosure.

FIG. 11 is a flow diagram for a method of an optimization model engine and optimization model solver, according to one embodiment of the present disclosure.

### DETAILED DESCRIPTION OF PREFERRED EMBODIMENTS

Presently, complex systems are modeled, in essence, as compartmentalized-but-related entities, resulting in potentially efficient models and controls within compartments, but lacking effective inter-compartmental modeling. Said otherwise, a complex system may have a number of models, with each model applied to a particular portion (a unit or sub-unit), but lacking effective modeling of the entirety complex system as an integrated entity. Such models are, to a degree, more or less ad hoc. A model of unit (Unit 1) of an organization may not respond to changes of another unit (Unit 2) having a real-world effect on Unit 1, nor reflecting the effect on the organization as an integrated system itself. In essence, such modeling provides an optimal model with little actual and meaningful control on the operation of the organization.

The present disclosure is directed to optimization or otherwise enhancing operation of systems using graph systems (e.g., graph data structures). The present disclosure is directed to optimization or otherwise enhancing operation of a system with a flow by using a graph system as a model of the system. The entities of the system can be represented by vertices of the graph system and the edges of the graph system can represent the flow or transport between entities of a given attribute for a unit of time. A graph system, according to the present disclosure, can also include graph layers, with each graph layer including one or more vertices and one or more intra-layer edges.

The present disclosure provides systems and methods employing graph systems to model operation of systems (simple and/or complex) in a manner that can provide both an optimal plan under ideal circumstances and can respond to circumstances or changes that deviate from the original optimal plan to effectuate operational changes to bring operation across the entire system to an optimal state under the new circumstances. Stated another way, the present disclosure provides systems and methods for modeling operations, including responsive modeling of operations, in real time, near real-time, and in projected time such that operations may be optimal under conditions that may vary over time.

A system is a set of interrelated and/or interdependent things (e.g., entities). Systems are ubiquitous in nearly every sector, field, discipline, and setting, including, for example, nature, society, community, chemistry, physics, biology, ecology, technology, commerce, finance and banking, operations, organizations, business, engineering, communication, industrial manufacturing, electricity and power, irrigation or plumbing, the earth, and the universe, to name just a very few. The entities (or elements) of a system can be virtually anything that can be labeled, including other systems. A flow (or exchange or transport) between the entities can be any relationship(s) that can exist between the entities. Systems theory, which is founded on an idea of the whole being greater than the sum of its parts (e.g., the entities), has been sought to be applied to nearly everything.

Some examples of systems are illustrative. A system can be a plumbing system, which can include several entities such as faucets, drains, valves and sinks to manage the flow of water, which is measured at cubic feet per second (cfs). A conduit for the flow can be the piping. A system can be an electrical system, which can include entities such as lights, switches, appliances, engines, batteries, and any other electrical component. The flow in an electrical system is the electrical current, measured in Amperes (formally defined as Coulombs/second), and the conduit is electrical wiring or wireless transmission of energy. In a financial system, the entities can be businesses, banks and people. The flow can be measured as $/hour, and the conduit of the flow can be a personal exchange, check, wire transfer, etc.

As illustrated by these examples, a flow represents transport between entities of a given property value for a given unit of time. A flow can be measured or calculated. In the present disclosure, the convention used is that positive flow represents flow into a vertex, while negative flow is defined as flow out of a vertex.

Optimizing a flow of a system can be desirable. Stated otherwise, optimizing operation of a system to minimize (or maximize) a flow of the system can be desirable for a variety of reasons, such as conserving or maximizing resources, timing, efficiency, cost, and the like. As the complexity of a system increases, whether in terms of number of entities or number of flows, optimizing operation of the system increases, potentially in an exponential fashion. Adjustments and/or changes to the structure of the system, such as adding or removing entities and/or flows, can further exacerbate the complexity of optimizing operation of the system. As a simple, easily understandable example, extending a line of pipe and adding two sprinklers to a sprinkler system will change operation and flow of water within the sprinkler system. And optimizing flow in the sprinkler system will change as a result.

A graph system, which is a data structure implementing a graph according to embodiments herein, can represent a system to be optimized. Graph data structures, such as weighted and layered graphs, have been used to describe optimization problems, such as in vehicle routing applications to minimize the distance, time, cost, and/or other quantities for vehicles traveling between customers. When described via weighted graphs, the graph would be required to have multiple attributes on an edge or multiple edges between vertices. For example, if the vehicle employed to travel from point A to point B adds another dimension to the total minimization in addition to minimizing time (e.g., cost of fuel), this constraint adds a variable input to the shortest path optimization. When described via layered graphs, the layers are typically used to resolve time or other constraints of the system such as distance or cost. Weighted or layered graph structures in these problems have been used to describe optimization of systems with a single flow system and limited constraints (for instance, minimizing time for vehicle routing). The applicability of these graph structures to systems with multiple flow systems, objectives and constraints is very limited.

The present inventors recognized that, in multi-objective optimizations, the different parameters can be better modeled with layered graphs for each flow system and associated properties germane to solving the optimization.

The present disclosure is directed to building or otherwise forming or configuring a graph system (e.g., a graph data structure) that represents a system, and using the graph system to construct an optimization model that can be optimized to determine control variables (or control attributes) to optimize or otherwise enhance operation of the system. A graph optimization engine can construct the optimization model that can be solved to generate a recommended control plan to a controller. The graph optimization engine can optimize the optimization model to determine the control values for one or more control variables to control operation (e.g., optimized or otherwise enhanced operation) of the system. A control engine can utilize the determined control values to control or otherwise dispatch a control plan to the electrical system.

In some embodiments of the present disclosure, a multi-layer graph system is formed to represent a complex system that includes multiple systems (e.g., subsystems) and interrelation(s) thereof. Each layer of the multi-layer graph system represents a system in a complex system. In the graph system representing a complex system, multiple layers (each representing a system) may be layered with each other when a relationship exists between the flow unit(s) of one system with the flow unit(s) of another system. This cross-relationship can be optimized to provide the minimum or maximum value for a property for the relationship under optimization, thereby managing the flow of the associated systems. Multiple flow system optimization layers can be associated to achieve multi-variant optimization across associated systems.

One example of a system (e.g., a complex system) including a relationship between two systems is the complex system in which a financial system interrelates with an electrical system. An electric utility provides electricity at a cost. In this scenario the electrical system and the financial system are associated. If the electrical demand and/or the cost are variable, the association between the two systems can be optimized to meet electrical demand at minimal cost (e.g., from the view of the consumer).

A multi-layer graph system can represent the complex system in which the financial system is interrelated with an electrical system. A financial graph layer provides a representation of the financial system. A vertex in the financial graph layer may represent a cost (e.g., a utility energy charge, a utility demand charge) or an incentive. An edge in the financial graph layer may represent an association of a vertex of the financial graph layer as an intra-layer edge with another vertex within the financial graph layer (e.g., to indicate association of two demand charges within the utility tariff) or as an inter-layer edge with a vertex of the electrical graph layer. An electrical graph layer provides a representation of the electrical system. A vertex in the electrical graph layer may represent a device or any physical entity able to consume energy (e.g., electric appliances, lighting, HVAC equipment), generate energy (e.g., solar photovoltaic array, wind turbine), or store energy (e.g., batteries). A vertex in the electrical graph layer may also represent an entity that is a device aggregate, which may be multiple devices that can be aggregated for convenience as collectively consuming energy (e.g., apartment or office), generating energy (e.g., solar or wind farm), or storing energy (e.g., ESS). Device aggregates may be further aggregated and represented as a vertex on the electrical graph layer. An edge in the electrical graph layer represents a transport or flow of energy through the wiring or connectedness between two devices, two aggregates, or a device and an aggregate.

In financial-electrical systems, or other types of systems, consider that other parameters such as time, distance, attendance, noise, etc. can be optimized. Other examples of multi-layer systems are multi-physics systems (e.g., electro-mechanical), and cyber-physical systems (e.g., electric power networks).

The present application is directed to systems, methods, apparatuses, and techniques for optimizing or otherwise enhancing operation of systems and use of graph data structures to generate and/or modify objective functions representing the one or more objectives of or for a system to be optimized.

A controller, according to one embodiment of the present disclosure, is to control operation of a system and can include a communication interface to connect to a communication path to one or more controllable elements of a system, a memory to store a graph system, and one or more processors to determine a set of control values for controlling the system. The graph system can include one or more vertices and one or more edges. Each vertex of the one or more vertices can represent an entity (including an aggregate of entities) in the system that includes one or more attributes. Each edge of the one or more edges represents a flow of an attribute with respect to at least one entity in the system. Each vertex of the one or more vertices and each edge of the one or more edges is associated with a modeling block that describes a set of associated constraint expressions Ψ and a set of associated cost expressions Ω for the one or more attributes (as pertaining to the associated vertex or edge).

The graph system may be received by the controller, such as from a client computing device, a user interface, data input, or any other form or medium. A user interface may enable or otherwise allow for user manipulation and/or modification to the graph system.

The one or more processors of the controller can construct an optimization model from the graph system. The optimization model can be constructed to include one or more objective functions. The optimization model can be constructed to include the set of associated cost expressions Ω (and the set of associated constraint expressions Ψ) of each modeling block associated with each vertex of the one or more vertices and each edge of the one or more edges according to the graph system. Stated otherwise, the modeling blocks include expressions for one or more objectives of the system (or a system within the more complex system) represented by the graph and constraints on the system (or a system within the more complex system). The one or more processors can utilize the structure or arrangement of the vertices and edges within the graph system to construct an optimization model that represents or otherwise includes the one or more objectives and complies with the one or more constraints. If or when the graph system is manipulated or otherwise modified (to update changes to the system to be optimized, or otherwise more accurately represent the system), the one or more processors of the controller can again construct the optimization model. The reconstructed optimization model can account for any manipulations or modifications to the graph system, including changes to the arrangement or structure of the vertices and edges and changes to the objectives and/or constraints.

The one or more processors can, based on the constructed optimization model, then determine a set of control values for a set of controllable output attributes (e.g., control attributes, control variables) of the one or more attributes. The set of control values may be determined in order to effectuate a change to the system for optimizing or otherwise enhancing operation of the system. The set of control values can be determined by the one or more processors utilizing an optimization algorithm to identify the set of control values that optimize (e.g., within a threshold level of optimal) the optimization model.

Once the set of control values are determined, the controller can provide the set of control values for the set of controllable output attributes to the one or more controllable elements of the system to be optimized. The set of control values can be provided via the communication interface to control operation of the system to be optimized.

In some embodiments, the graph system further includes one or more graph layers each including one or more of the one or more vertices and one or more intra-layer edges of the one or more edges. As mentioned above, the system to be optimized may include multiple systems and each graph layer of the one or more graph layers can represent a system of one or more systems. Each graph layer can support one (and may only support one) flow of an attribute. Each intra-layer edge can represent the flow of the attribute with respect to at least one vertex within the graph layer.

Each graph layer can be associated with a modeling block that describes a set of associated cost expressions Ω for the one or more attributes (as pertaining to the associated graph layer (i.e., the flow of the attribute is supported by the associated graph layer and the one or more intra-layer edges therein)). The modeling block associated with each graph layer can also describe a set of associated constraint expressions Ψ. The one or more processors of the controller can construct the optimization model from the graph system to include the set of associated cost expressions Ω of each modeling block associated with each graph layer.

Each graph layer of a multi-layer graph system can represent or otherwise include a graph layer objective that is represented by a graph layer objective function, which can be an aggregation of the associated cost expressions Ω for the one or more attributes (e.g., as pertaining to the associated graph layer). The one or more processors can construct the optimization model from the graph system to include the one or more graph layer objective functions corresponding to the one or more graph layers. The set of control values are determined by the one or more processors utilizing an optimization algorithm to identify the set of control values that optimize the optimization model that includes the one or more graph layer objective functions corresponding to the one or more graph layers.

As can be appreciated, in a complex system of multiple systems (represented by a multi-layer graph system) where each of the multiple systems has a different objective (represented by a graph layer that represents or otherwise includes that objective represented as an objective function) the overall objective of the complex system is not a simple aggregation of all the cost expressions of the associated modeling blocks, but rather there may be a corresponding layering of handling or consideration of objectives. The optimization model constructed from a multi-layer graph system is potentially composed of multiple objectives (represented as objective functions), which the controller must solve simultaneously to optimize operation of the system to be optimized. For example, in a thermo-electrical system, the optimization model may be solved by maximizing comfort (objective #1) while minimizing operating cost (objective #2).

As used herein, a “control attribute” is a characteristic or feature which may have a value assigned to or associated with it. The value (control value) of a control attribute is set, for example manually or automatically (e.g., via heuristics, optimization, any other algorithm), internally (e.g., logic embedded within the entity) or externally, and alters the state of an entity in a system. It follows that every controllable entity has one or more control attributes, and conversely, a control attribute may only belong to a controllable entity. By way of example, the dispatch power of a battery ESS can be a control attribute that alters the state (e.g., state of charge) of the system. As another example, a 10-centimeters-wide rectangle may have a control attribute of “width” (other terms, labels, etc., may be used to represent a width).

As used herein, a “control variable” is a placeholder for a value, or a value which may be assigned to or associated with a characteristic or feature (control attribute) and may be modified under appropriate circumstances or conditions. A control variable is the manifestation of a control attribute in a mathematical model or graph system as described herein. A control variable is a “variable” because its value is determined, such as manually or automatically (e.g., via heuristics, optimization or any other math algorithm) and changes as the states of the entity (and/or the system of which the entity is a part) change. In the foregoing examples, the dispatch power of a battery ESS may be a control variable being solved for as part of an optimization model minimizing the operating cost of a building electrical system, or the 10-centimeters-wide rectangle may have a control variable of “10-centimeters” assigned to or associated with the control attribute “width.”

Example embodiments of the present disclosure are described below with reference the Figures. The example embodiments are described with reference to an electrical system. However, it should be appreciated and otherwise understood that the disclosed systems, methods, and techniques of generating and/or utilizing a graph system from which a model (e.g., an optimization model) can be constructed can apply to many systems other than electrical systems.

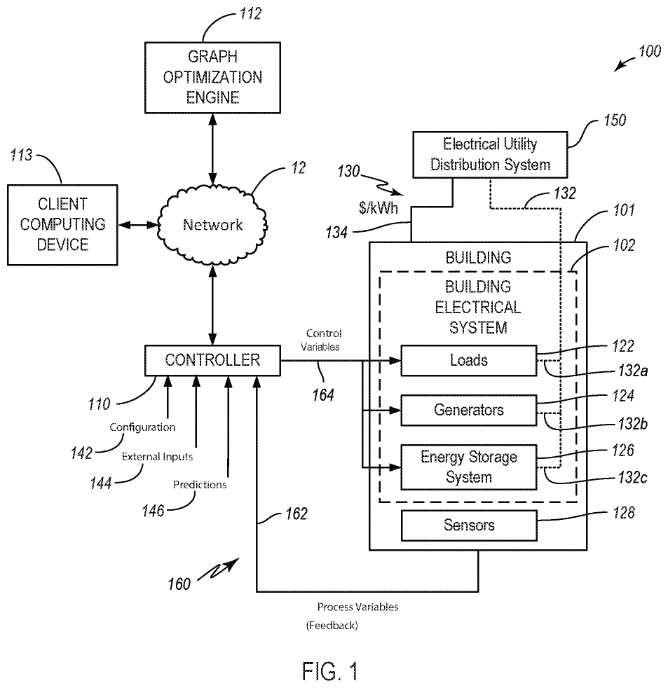

FIG. 1 is a block diagram of a controllable electrical system 100, according to one embodiment of the present disclosure, including a controller utilizing an optimizing graph system. Stated otherwise, FIG. 1 is a representative diagram of a system 100 including an electrical utility distribution system 150 (e.g., at least a connection thereto) and a controllable building electrical system 102 (e.g., for a building 101) that is controlled by a controller 110. A graph optimization engine 112 can receive (e.g., via a network 12) user input from a client computing device 113 providing graph definition data. The graph optimization engine 112 can receive graph definition data, such as from the controller 110 via the network 12. The graph definition data may be received by the controller 110 as static configuration data 142. The graph definition data provides topology, structure, arrangement, specifications, constraints (structural, component, system), and the like of the electrical utility distribution system 150 and the building electrical system 102. Stated otherwise, the graph definition data may include static configuration data (as compared to operational configuration data). The graph optimization engine 112 can use the received user input and/or graph definition data to build a graph system representing an interaction 130 between the building electrical system 102 and the electrical utility distribution system 150, and can generate an optimization model that can be used by the controller 110 to optimize or otherwise enhance operation of the building electrical system 102 in drawing power from the electrical utility distribution system 150.

The graph optimization engine 112 can receive external inputs 144, such as may be provided to or otherwise received by the controller 110 and can use the received external inputs 144 in building the graph system representing the building electrical system 102 and electrical utility distribution system 150. The graph optimization engine 112 can receive predictions 146 (e.g., load predictions, generation predictions, battery state of charge (SoC) predictions), such as may be provided to or otherwise received by the controller 110 and can use the predictions 146 in building the graph system representing the building electrical system 102 in connection with the electrical utility distribution system 150.

The building electrical system 102 includes one or more loads 122, one or more generators 124, an energy storage system (ESS) 126, and sensors 128. The building electrical system 102 is electrically coupled 132 to the electrical utility distribution system 150, and therefore may be considered on-grid. More specifically, the electrical utility distribution system 150 is electrically coupled 132a, 132b, 132c to, respectively, the loads 122, the generators 124, and the ESS 126 of the building electrical system 102. An exchange of electricity (e.g., kilowatts) can occur between the electrical utility distribution system 150 and the loads 122, the generators 124, and/or the ESS 126 of the building electrical system 102. An exchange of money (e.g., at a rate in dollars per kilowatt hour ($/kwh)) 134 can also occur between the electrical utility distribution system 150 and the building 101 (e.g., an operator of the building).

The generators 124 and or ESS 126 can give an operator of the building 101 an ability to control net consumption and delivery of electrical energy at a point of interconnection with the electrical utility distribution system 150. For example, if electricity supply and/or delivery costs (e.g., charges) are high at a particular time of day, the generator 124 and/or the ESS 126 can generate/discharge electrical energy to reduce the net consumption of the building electrical system 102, and thus reduce costs to the operator of the building 101. Likewise, when electricity rates are low, the building electrical system 102 may draw electrical power from the electrical utility distribution system 150 to charge the ESS 126; the lower-cost energy stored in the ESS 126 can then be used to reduce net consumption and thus costs to the operator of the building 101 at times when the supply and/or delivery costs are high. There are many ways a generator 124 or an ESS 126 can provide value.

One possible way in which an ESS 126 can provide value (e.g., one or more value streams) is by reducing time-of-use (ToU) supply charges. ToU supply charges are typically pre-defined in a utility's tariff document by one or more supply rates and associated time windows. ToU supply charges may be calculated as the supply rate multiplied by the total energy consumed during the time window. ToU supply rates in the United States may be expressed in dollars per kilowatt-hour ($/kWh). The ToU supply rates and time windows may change from time to time, for example seasonally, monthly, daily, or hourly. Also, multiple ToU supply rates and associated time windows may exist and may overlap. ToU supply rates are time-varying which makes them different from “flat” supply rates that are constant regardless of time of use. In FIG. 1 the exchange of money at a rate of $/kWh may be a ToU supply rate. An automatic controller may be beneficial and may be desirable to enable intelligent actions to be taken as frequently as may be needed to utilize a generator 124 and/or an ESS 126 to reduce ToU supply charges.

Another possible way in which a generator 124 and/or an ESS 126 can provide value is by reducing demand charges. Demand charges are electric utility charges that are based on the rate of electrical energy consumption (also called “demand”) during particular time windows (which we will call “demand windows”). A precise definition of demand and the formula for demand charges may be defined in a utility's tariff document. For example, a tariff may specify that demand be calculated at given demand intervals (e.g., 15-minute intervals, 30-minute intervals, 40-minute intervals, 60-minute intervals, 120-minute intervals, etc.). The tariff may also define demand as being the average rate of electrical energy consumption over a previous period of time (e.g., the previous 15 minutes, 30 minutes, 40 minutes, etc.). The previous period of time may or may not coincide with the demand interval. Demand may be expressed in units of power such as kilowatts (kW) or megawatts (MW). The tariff may describe one or more demand rates, each with an associated demand window (e.g., a period of time during which a demand rate applies). The demand windows may be contiguous or noncontiguous and may span days, months, or any other total time interval per the tariff. Also, one or more demand windows may overlap which means that, at a given time, more than one demand rate may be applicable. Demand charges for each demand window may be calculated as a demand rate multiplied by the maximum demand during the associated demand window. Demand rates in the United States may be expressed in dollars per peak demand (in units $/kW). As can be appreciated, demand tariffs may change from time to time, or otherwise vary, for example annually, seasonally, monthly, or daily. An automatic controller may be beneficial and may be desirable to enable intelligent actions to be taken as frequently as may be needed to utilize an ESS 126 to reduce demand charges.

Another possible way in which a generator 124 and/or an ESS 126 can provide value is through improving utilization of local generation. For example, an ESS 126 can facilitate maximizing self-consumption of renewable energy generated by a renewable generator 124 by reducing fluctuations of the renewable generator 124 such as during cloud passage on solar photovoltaic (PV) arrays. An automatic controller may be beneficial and may be desirable to enable intelligent actions to be taken to utilize locally generated power more effectively and efficiently.

Another possible way in which a generator 124 and/or an ESS 126 can provide value is through leveraging local contracted or incentive maneuvers. For example, New York presently has available a Demand Management Program (DMP) and a Demand Response Program (DRP). These programs, and similar programs, offer benefits (e.g., a statement credit) or other incentives for consumers to cooperate with the local utility(ies). An automatic controller may be beneficial and may be desirable to enable intelligent actions to be taken to utilize an ESS to effectively leverage these contracted or incentive maneuvers.

Still another possible way in which an ESS 126 can provide value is through providing reserve battery capacity for backup power in case of loss of supply. An automatic controller may be beneficial and may be desirable to enable intelligent actions to be taken to build and maintain such reserve battery backup power with an ESS 126.

As can be appreciated, an automatic controller (e.g., controller 110) that can automatically operate the building electrical system 102 to take advantage of any one or more of these value streams may be desirable and beneficial. As can also be appreciated, designing and/or implementing an automatic controller is complicated and not easily optimized or otherwise made effective. The challenge of automatic control is further complicated in situations where the building electrical system 102 is subject to structural changes, such as when loads are taken offline (e.g., a resident of an apartment building moves in or vacates, heavy electrical machinery is installed or decommissioned, etc.), or when more efficient and/or renewable generators may be added or substituted.

The present disclosure provides systems and methods for generating or otherwise forming or configuring a graph system (e.g., a graph data structure) that represents the building electrical system 102 in connection with the electrical utility distribution system 150, and for using the graph system to construct an optimization model that can be optimized to determine control values for control attributes (or control variables) to optimize or otherwise enhance operation of the building electrical system 102.

The diagram of FIG. 1 is a control diagram in which the controller 110 is shown on the left-hand side and the building electrical system 102, sometimes called the “plant,” is on the right-hand side. A feedback loop 160 includes process variables 162 or other feedback information communicated from the building electrical system 102 to the controller 110 and control variables 164 sent from the controller 110 to the one or more of the systems/sub-systems (e.g., loads 122, generators 124, ESS 126, sensors 128) of the building electrical system 102. The controller 110 may include electronic hardware and software in one embodiment. In one example arrangement, the controller 110 includes one or more processors and suitable storage media, which stores programming in the form of executable instructions which are executed by the processors to implement the control processes.

The loads 122 are consumers of electrical energy within the building electrical system 102. Examples of loads are air conditioning systems, motors, electric heaters, machinery, etc. The sum of the loads' electricity consumption rates can be measured in units of power (e.g., kW) and simply called “load” (e.g., a building load). The electrical utility distribution system 150 provides electrical energy to the building electrical system 102, including to the loads 122 and to the ESS 126. In some embodiments, the electrical utility distribution system 150 may receive electrical energy from the building electrical system 102, including from the generators 124 and from the electrical utility distribution system 150. The electrical utility distribution system 150 also charges the building electrical system 102 (or building 101 operator) for the energy kWh consumed at a usage rate (e.g., $/kWh). The electrical utility distribution system 150 can also exact other charges (e.g., demand charges, fines, penalties) with respect to the energy usage of the building electrical system 102.

The generators 124 may be devices, apparatuses, or other means for generating electrical energy within the building electrical system 102. Examples are solar photovoltaic systems, wind generators, combined heat and power (CHP) systems, and diesel generators or “gen-sets.” The sum of electric energy generation rates of the generators 124 can be measured in units of power (e.g., kW) and simply referred to as “generation.” As can be appreciated, a load 122 may also generate power at certain times. An example may be an elevator system that is capable of regenerative operation when the carriage travels down. In some embodiments, the electrical utility distribution system 150 can purchase power from the building electrical system 102 or provide another benefit (e.g., statement credit, rate reduction).

With continued reference to FIG. 1, the controller 110 may receive inputs that are used to determine (or otherwise inform a determination of) control attributes or control variables 164 to control the building electrical system 102. The inputs to the controller 110 may include process variables 162, configuration data 142, external inputs 144, and/or predictions 146.

The building electrical system 102 may provide information to the controller 110, such as in a form of providing process variables 162. The process variables 162 may provide information, or feedback, as to a status of the building electrical system 102 and/or one or more components (e.g., loads 122, generators 124, ESSs 126) thereof. For example, the process variable may provide one or more measurements of a state of the building electrical system 102. The sensors 128 may gather measurements that are communicated via the process variables. The controller 110 receives the process variables 162 for determining values for control variables (or control attributes) 164 to be communicated to the building electrical system 102 to effectuate a change to the building electrical system 102 toward meeting an overall objective (or one or more objectives) for the building electrical system 102. For example, the controller 110 may provide a control variable 164 to adjust the load 122, to increase or decrease generation by the generator 124, and/or to utilize (e.g., charge or discharge) the ESS 126.

Process variables 162 are typically measurements (e.g., from the sensors 128) of the state of the building electrical system 102 and are used by the controller 110 to, among other things, determine how well objectives are being met. These process variables 162 may be read and used by the controller 110 to generate new control variable 164 values. The rate at which process variables 162 are read and used by the controller 110 depends upon the application but typically ranges from once per millisecond to once per hour. For battery ESS applications, the rate is often between 10 times per second and once per 15 minutes. Examples of process variables may include unadjusted net power, adjusted net power, unadjusted demand, demand, load (e.g., load energy consumption for one or more loads), generation for one or more loads, actual ESS charge or generation rate for one or more ESS, frequency, energy storage device SoC (e.g., as a percentage %) for one or more ESS, energy storage device temperature (deg. C.) for one or more ESS, and/or electrical meter outputs such as kilowatt-hours (kWh) or demand.

Unadjusted net power may refer herein to load minus generation in the absence of active control by the controller 110 described herein. For example, if at a given moment the building electrical system 102 has loads 122 consuming 100 kW, and a generator 124 (e.g., a solar photovoltaic system) generating at 25 kW, the unadjusted net power is 75 kW. Similarly, if at a given moment the building electrical system 102 has loads 122 consuming 70 kW, and a generator 124 (e.g., solar photovoltaic system) generating at 100 kW, the unadjusted net power is −30 kW. As a result, the unadjusted net power is positive when the load energy consumption exceeds generation, and negative when the generation exceeds the load energy consumption.

ESS power refers herein to a sum of a rate of electric energy consumption of an ESS 126. If ESS power is positive, an ESS 126 is charging (consuming energy). If ESS power is negative, an ESS 126 is generating (delivering energy).

Adjusted net power refers herein to unadjusted net power plus the power contribution of any controllable elements such as an ESS 126. Adjusted net power is therefore the net rate of consumption of electrical energy of the electrical system considering all the loads 122, the generators 124, and the ESSs 126 in the system, as controlled by the controller 110.

Unadjusted demand is demand defined by the locally applicable tariff, but only based on the unadjusted net power. In other words, unadjusted demand does not consider the contribution of any ESS 126.

Adjusted demand or simply “demand” is demand as defined by the locally applicable tariff, based on the adjusted net power, which includes the contribution from any and all controllable elements such as ESSs 126. Adjusted demand is the demand that can be monitored by the electrical utility distribution system 150 and used in the demand charge calculation.

The controller 110 may also receive configuration data 142. The configuration data 142 may include static configuration data, which may specify components, structures, objectives, and/or one or more static constraints (e.g., ranges, limits) of the building electrical system 102 in connection with the electrical utility distribution system 150, and which can be provided to the graph optimization engine 112 as noted above to generate a graph system. The static configuration data may provide or otherwise include graph definition data. Examples of static configuration data may include: ESS type (for example if a battery: chemistry, manufacturer, and cell model); ESS configuration (for example, if a battery: number of cells in series and parallel) and constraints (such as maximum charge and discharge powers); ESS efficiency properties; ESS degradation properties (as a function of SoC, discharge or charge rate, and time); electricity supply tariff (including ToU supply rates and associated time windows); electricity demand tariff (including demand rates and associated time windows); electrical system constraints such as minimum power import; and ESS constraints such as SoC limits or power limits.

The configuration data 142 can also include operational configuration data, which may include control strategy (e.g., 2-parameter control, 3-parameter control), forecasting strategy (e.g., designation of forecaster choice), optimization strategy (e.g., optimizing cadence (e.g., every minute, 5 minutes, 15 minutes), optimizing time horizon (e.g., 24 hours, 36 hours, 48 hours)), and operational constraints (e.g., time varying ESS constraints, time varying import constraints). The controller 110 can utilize the operational configuration data in determining values of control variables for controlling the building electrical system 102. Operational configuration data may include, set, or otherwise pertain to a status, state, constant, or other aspect of the operation of the building electrical system 102.

The controller 110 may also receive external inputs 144, which may inform the determination of the values of the control variables 164. External inputs 144 are variables that may be used by the controller 110 and that may change during operation of the controller 110. A set of external inputs 144 may be received by the controller 110. The set of external inputs 144 may provide indication of one or more conditions that are external to the controller 110 and the building electrical system 102 in connection with the electrical utility distribution system 150. The controller 110 may also receive predictions 146, such as load predictions of the loads 122 of the building electrical system 102 for an upcoming time domain or period. Examples of predictions 146 may include weather forecasts (e.g., irradiance for solar generation and wind speeds for wind generation), weather reports, fuel costs, and event data (e.g., occupancy predictions). In some embodiments, tariffs (e.g., demand rates defined therein) may change during the operation of the controller 110 and may therefore be received as an external input 144. In some embodiments, historic data may be provided as external input 144, such as historic data for unadjusted net power or unadjusted demand, weather data, occupancy, and the like.

Predictions 146 may be included with external inputs 144 or provided separately to the controller 110 (e.g., such as from a predictions engine). The predictions 146 may include predictions of one or more of loads 122, generation by the generators 124, and SoC of the ESS 126 of the building electrical system 102. The predictions 146 may include predictions of rates in markets where a tariff is not fixed ahead of time, but changes dynamically as the grid consumes more (or less) power.

The controller 110 may attempt to meet certain objectives by changing a value associated with one or more control variables 164, as appropriate. The objectives may be predefined (e.g., by a user, the graph optimization engine 112), and controllers striving (e.g., control) toward the objectives may also be dependent on time, on any external inputs 144, on any predictions 146, on any process variables 162 that are obtained from the building electrical system 102, and/or on the control variables 164 themselves. Some examples of objectives for different applications are: minimize demand (kW) over a prescribed time interval, minimize demand charges ($) over a prescribed time interval, minimize total electricity charges ($) from the grid, reduce demand (kW) from the grid by a prescribed amount during a prescribed time window, and/or maximize the life of the energy storage device.

Objectives can also be compound—that is, an overall objective can be comprised of multiple individual objectives. One example of a compound objective is to minimize demand charges while maximizing the life of the energy storage device. Other compound objectives including different combinations of individual objectives are possible.

The controller 110 can operate under one or more constraints. The controller 110 may operate under the constraints by, for example, changing a value associated with one or more control variables 164, as appropriate. The constraints may be physical limitations based on the static configuration, control strategies, and/or operational constraints. The constraints may be received with or in conjunction with configuration data. Some examples of constraints for different applications are prevent export to the grid, restrict state-of-charge of the ESS 126 within limits, disregard recommended control plan (from graph optimization engine 112) if controlling site electrical system to 2-parameter control, disregard graph optimization engine recommended control plan (e.g., ESS dispatch) if the site electrical system operator wishes to control the ESS 126 manually, and/or modify the optimization engine recommended control plan if one or more control devices have disconnected from the network.

As noted, the inputs that the controller 110 may use to determine (or otherwise inform a determination of) the control variables 164 can include the process variables 162, the configuration data 142, the external inputs 144, and/or the predictions 146.

The outputs of the controller 110 are control values for the control variables 164 (or output attributes) that can affect the building electrical system 102 behavior. The control values may each correspond to one or more controllable elements of a system to be controlled. Examples of control variables 164 for which a control value can be output by the controller 110 are ESS power command (kW or %) (e.g., an ESS power command of 50 kW would command the ESS 126 to charge at a charge point of 50 kW, and an ESS power command of −20 kW would command the ESS 126 to discharge at 20 kW), building or subsystem net power increase or reduction (kW or %), and/or renewable energy increase or curtailment (kW or %) (e.g., a photovoltaic (PV) system curtailment command of −100 kW would command a PV system to limit generation to no less than −100 kW). In some embodiments, a positive sign (+) indicates power consumption and a negative sign (−) indicates power generation.

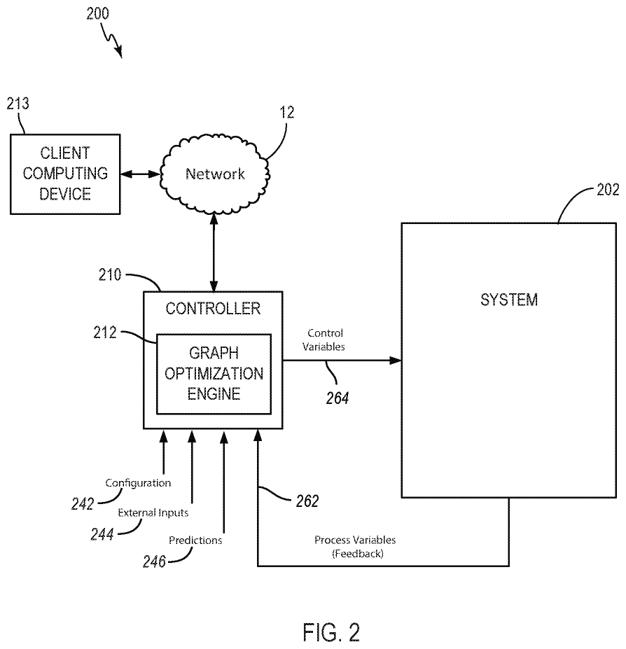

The graph optimization engine 112 can be in electronic communication with the controller 110 over a network 12 (e.g., the Internet, a wireless communication network). In other embodiments, the graph optimization engine 112 may be integrated to or otherwise combined with the controller 110 (e.g., similar to the controller 210 shown in FIG. 2 and described with reference to the same). A client computing device 113 may also communicate with the graph optimization engine 112 via the network 12. The graph optimization engine 112 receives graph definition data, such as through user input to the graph optimization engine 112, from the client computing device 113, or as configuration data from the controller 110. The graph definition data may indicate entities of a system and flows (or other relations) between the entities. The graph definition data may represent or indicate a topology of the system. The graph optimization engine 112 can also receive external inputs 144, predictions 146, and/or process variables 162 from the controller 110, via the network 12.

The graph optimization engine 112 can generate a graph system (e.g., data structure) based on the graph definition data, external inputs 144, predictions 146, and/or process variables 162. The graph system can include one or more vertices and one or more edges, each vertex of the one or more vertices representing an entity in the system that includes one or more attributes and each edge of the one or more edges representing a flow of an attribute with respect to at least one entity in the system. Each vertex of the one or more vertices and each edge of the one or more edges is associated with a modeling block that describes a set of associated constraint expressions Ψ and a set of associated cost expressions Ω for the one or more attributes as pertaining to the associated vertex or edge. The graph system constructed by the graph optimization engine 112 provides a simple, understandable representation of the system and can be easily modified to more accurately represent the system, particularly if the system is modified.

The graph optimization engine 112 can use the graph system to construct an optimization model, which can be utilized by the controller 110 in optimizing or otherwise enhancing operation of the building electrical system 102. The optimization model can include one or more objective functions, as discussed above. The one or more objective functions may define or inform the objectives of the controller 110. The objective functions may be dependent on time, on any external inputs, on any predictions, and on any process variables that are obtained from the building electrical system 102, and/or on the control variables 164 themselves. The optimization model can also include the set of associated cost expressions Ω (e.g., the objective functions can be an aggregate of, cumulation of, or otherwise include the cost expressions Ω) and the set of associated constraint expressions Ψ of each modeling block associated with each vertex of the one or more vertices and each edge of the one or more edges according to the graph system. The optimization model generated by the graph optimization engine 112 can then be optimized and then utilized by the controller 110 to optimize or otherwise enhance the operation of the building electrical system 102.

The system 100 of FIG. 1 is described in the context of electrical power systems, and specifically includes a building electrical system 102. As can be appreciated, the system 100 could pertain to any controllable system, and the graph optimization engine 112 can generate a graph system and optimization model for any such controllable system.

FIG. 2 is a block diagram illustrating a system architecture 200 of an optimizing graph system, according to another embodiment of the present disclosure. A system 202 is controlled by a controller 210 that includes a graph optimization engine 212. The system 202 may be a complex system comprising multiple systems (hereafter, “complex system 202”). For example, the complex system 202 may include a building electrical system and a utility distribution system (similar to what is illustrated in FIG. 1). The controller 210 may include a communication interface to connect to a communication path to one or more controllable elements of the complex system 202. The controller 210 may include a memory to store a graph system generated by the graph optimization engine 212.

The controller 210 receives configuration data 242, external data 244, and/or predictions 246 as inputs. The controller 210 also receives process variables 262 from the complex system 202, as feedback. The controller 210 may alternatively or in addition receive input, such as configuration data 242, external data 244, and/or predictions 246 via a remote client computing device 213 coupled to the controller 210 via the network 12. The controller 210, and more particularly the graph optimization engine 212 thereof, generates a graph system based on the configuration data, external inputs, and predictions.

The graph optimization engine 212 of the controller 210 can generate a graph system that includes one or more vertices and one or more edges. Graph definition data may specify or otherwise define the one or more vertices and one or more edges. Each vertex of the one or more vertices represents an entity in the system that includes one or more attributes. Each edge of the one or more edges represents a flow of an attribute with respect to at least one entity in the complex system 202. Each vertex of the one or more vertices and each edge of the one or more edges is associated with a modeling block, which are depicted and described more fully below. The modelling block describes a set of associated constraint expressions Ψ and a set of associated cost expressions Ω for the one or more attributes as pertaining to the associated vertex or edge.

The graph system generated by the graph optimization engine 212 can include one or more graph layers each including one or more vertices and one or more intra-layer edges. Each graph layer can support one (e.g., only one) flow of an attribute. Each intra-layer edge represents the flow of the attribute with respect to at least one vertex within the graph layer. Each graph layer is associated with a modeling block that describes a set of associated cost expressions Ω for the one or more attributes as pertaining to the associated graph layer.

The attributes of the vertices, edges, and graph layers of a graph system can each be a characteristic of the associated vertex, edge, or a graph layer that is inherent to the associated modeling block. Each attribute can be an input attribute or an output attribute. An input attribute can represent a characteristic input to a modeling block. An input attribute is either static or able to be at least one of measured, forecasted, and calculated. An output attribute can represent a characteristic output from a modeling block, and each output attribute is one of a diagnostic output attribute and a controllable output attribute.

As noted, each graph layer is associated with a modeling block that describes a set of associated cost expressions Ω for the one or more attributes as pertaining to the associated graph layer. Stated otherwise, the flow of the attribute is supported by the associated graph layer and the one or more intra-layer edges therein. The modeling block can also describe a set of associated constraint expressions Ψ. The constraint expressions Ψ represent or otherwise specify constraints within which the complex system 202 should or must operate. The constraints may be physical limitations based on the static configuration, control strategies, and/or operational constraints.

The graph system generated by the graph optimization engine 212 can include one or more inter-layer edges extending between a first graph layer and a second graph layer. An inter-layer edge represents a flow of an attribute that is identical to the flow attribute of one of the first graph layer and the second graph layer. As the complex system 202 can be a complex system encompassing multiple discrete systems (each having a different flow attribute), each graph layer can be representative of a discrete system of the multiple discrete systems. An inter-layer edge represents a relation between a first discrete system represented by the first graph layer and a second discrete system represented by the second graph layer. Controllable elements of the complex system 202 can be included in a physical system (e.g., an electrical system) and the physical system can be one of the first discrete system and the second discrete system between which an inter-layer edge extends.

The graph optimization engine 212 can use the graph system to construct an optimization model, which can be utilized by the controller 210 in optimizing or otherwise enhancing operation of the complex system 202. The optimization model represents an overall objective and can be a cumulative (or aggregate) of the graph layer objectives.

Each graph layer may have a graph layer objective. The graph layer objective may be represented by a graph layer objective function that is an aggregation of the associated cost expressions Ω for the one or more attributes (as pertaining to the associated graph layer). The graph optimization engine 212 can construct the optimization model from the graph system to include the one or more graph layer objective functions corresponding to the one or more graph layers. The graph optimization engine 212 can construct the optimization model from the graph system to include the set of associated cost expressions Ω of each modeling block associated with each graph layer. Each graph layer objective can in turn be cumulative (or an aggregate) of the cost expressions Ω of the modeling blocks for the layer and the vertices and edges thereof. The optimization model, accordingly, potentially incorporates or otherwise includes multiple objectives, which can be solved simultaneously. For example, in a thermo-electrical system, the optimization model may be solved by maximizing comfort (objective #1) while minimizing operating cost (objective #2).

The graph optimization engine 212 can also generate the optimization model to be subject to the set of associated constraint expressions Ψ of each modeling block associated with each graph layer, vertex, and edge of the graph system.

The graph optimization engine 212 utilizes the optimization model to determine values for the controllable output attributes that optimize the optimization model. The graph optimization engine 212 can utilize the optimization model as an objective function (e.g., an overall objective function for the complex system 202) and can optimize the optimization model to determine optimal control values for the control variables to send to control the complex system 202 (to effectuate a change to the complex system 202 toward meeting a controller objective for the complex system 202). Stated otherwise, the graph optimization engine 212 may optimize the optimization model to determine optimal control values for the control variables 264 that, if used for control, would effectuate a change to the complex system 202 to optimize or otherwise enhance operation of the complex system 202.

The graph optimization engine 212 can utilize an optimization algorithm to identify a set of control values that optimize the optimization model. The optimization algorithm may optimize the optimization model by determining values that optimize the set of associated cost expressions Ω of each modeling block associated with each vertex, edge, and graph layer, in accordance with the set of associated constraint expressions Ψ of each modeling block.

The set of control values that optimize the optimization model can be a recommended control plan. The recommended control plan can include a set of values with one value for each control attribute of the optimization model (which corresponds to a controllable element of the complex system 202). The recommended control plan can be an optimal control plan.

In some embodiments, the recommended control plan may be a set (e.g., one or more) of values corresponding to a set of control attributes for a time period. In some embodiments, the recommended control plan may include a plurality of sets of values, each set corresponding to a set of control attributes for a time period of a plurality of time periods for an upcoming time domain.

The controller 210, as noted, receives process variables 262, configuration data 242, external data 244, and predictions 246 and can utilize one or more of these in conjunction with a recommended control plan (e.g., an optimal control plan from the graph optimization engine 212) to provide a dispatch control plan to control the complex system 202. The dispatch control plan may be the recommended control plan (e.g., an optimal control plan) in some instances. In other instances, the controller 210 may adjust control values (or control variables 264) of a recommended control plan according to additional information received through one or more of the process variables 262, configuration data 242, external data 244, and predictions 246, to derive the dispatch control plan. For example, if a forecast or other prediction 246 on which the graph optimization engine optimized the optimization model was in actuality inaccurate to a material degree, the control engine may adjust the recommended control plan to include in the dispatch control plan appropriate control variables 264 that compensate for or otherwise adjust for the discrepancy between the forecast and the actual. As one specific example, if load was predicted to be higher than it actually is and there is a constraint by the utility to consume at least 50 kW of power or greater, this constraint could be violated by discharging a battery, in which case the adjustment would be made to discharge at a lower power than recommended or even charge to meet that minimum required load consumption.

Similar to the recommended control plan (e.g., an optimal control plan) determined by optimizing the optimization model, the dispatch control plan can be a set (e.g., one or more) of values corresponding to a set of control variables 264 for a time period. In some embodiments, the recommended control plan may include a plurality of sets of values, each set corresponding to a set of control variables 264 for a time period of a plurality of time periods for an upcoming time domain.

In other embodiments, the controller 210 can determine values for a set of control parameters, which are then used (e.g., by the controller or by another component or process) to determine control values for control variables 264 to be communicated to a system to be controlled. For example, the controller 210 may include an optimizer and a high-speed controller. The optimizer may optimize an optimization model to generate a recommended control plan and then generate a dispatch control plan based on the recommended control plan, process variables 262, external data 244, and predictions 246. The optimizer may generate the dispatch control plan as control parameters that are provided to the high-speed controller, which may then process the control parameters to generate and provide the control variables 264 to the system.

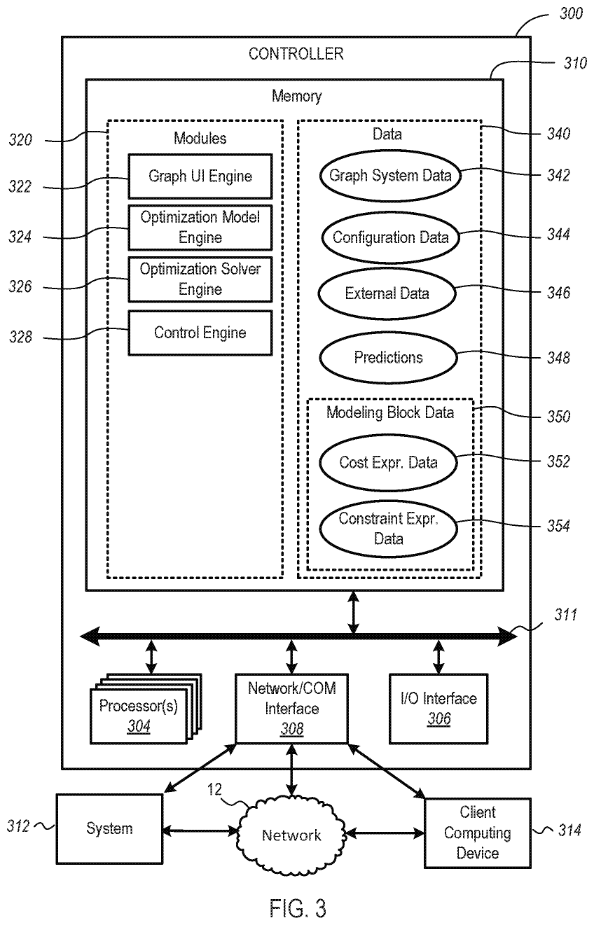

FIG. 3 diagrams a system architecture of a controller 300 for an optimizing graph system, according to one embodiment of a present disclosure. The controller 300 may be similar in some respects to the controller 110 and 210 of FIGS. 1 and 2. The controller 300 can receive data and operate modules (e.g., execute machine-readable instructions) to implement, generate, build or otherwise form or configure a graph system that represents a system 312 to be controlled. The graph system can then be used by the controller 300 to generate an optimization model that can be used to determine control values to optimize or otherwise enhance operation of the system 312 to be controlled. The system 312 may be similar in some respects to the building electrical system 102 of FIG. 1 and/or the complex system 202 of FIG. 2. The controller 300 is communicatively coupled to the system 312 directly or via a network 12. In one embodiment, the controller 300 may have an exclusive communication connection to the system 312. A client computing device 314 can facilitate interaction with the controller 300 and/or the system 312. The controller 300 includes one or more processors 304, an input/output (I/O) interface 306, a network or other communication (COM) interface 308 to couple to the network 12, an electronic memory 310 and/or other computer readable storage medium, and a system bus 311.

The one or more processors 304 may include one or more general purpose devices, such as an Intel®, AMD®, or other standard microprocessor. The one or more processors 304 may include a special purpose processing device, such as ASIC, SoC, SiP, FPGA, PAL, PLA, FPLA, PLD, or other customized or programmable device. The one or more processors 304 perform distributed (e.g., parallel) processing to execute or otherwise implement functionalities of the present embodiments. The one or more processors 304 may run a standard operating system and perform standard operating system functions. It is recognized that any standard operating systems may be used, such as, for example, Microsoft® Windows®, Apple® MacOS®, Disk Operating System (DOS), UNIX, IRIX, Solaris, SunOS, FreeBSD, Linux®, ffiM® OS/2® operating systems, and so forth.

The input/output interface 306 may facilitate interfacing with one or more input devices and/or one or more output devices. The input device(s) may include a keyboard, mouse, touch screen, light pen, tablet, microphone, sensor, or other hardware with accompanying firmware and/or software. The output device(s) may include a monitor or other display, printer, speech or text synthesizer, switch, signal line, or other hardware with accompanying firmware and/or software.

The network/COM interface 308 may facilitate communication with other computing devices and/or networks 12, such as the Internet and/or other computing and/or communications networks. The network/COM interface 308 may be equipped with conventional network connectivity, such as, for example, Ethernet (IEEE 802.3), Token Ring (IEEE 802.5), Fiber Distributed Datalink Interface (FDDI), or Asynchronous Transfer Mode (ATM). Further, the network/COM interface 308 may be configured to support a variety of network protocols such as, for example, Internet Protocol (IP), Transfer Control Protocol (TCP), Network File System over UDP/TCP, Server Message Block (SMB), Microsoft® Common Internet File System (CIFS), Hypertext Transfer Protocols (HTTP), Direct Access File System (DAFS), File Transfer Protocol (FTP), Real-Time Publish Subscribe (RTPS), Open Systems Interconnection (OSI) protocols, Simple Mail Transfer Protocol (SMTP), Secure Shell (SSH), Secure Socket Layer (SSL), and so forth.

The system bus 311 may facilitate communication and/or interaction between the other components of the system, including the one or more processors 304, the memory 310, the input/output interface 306, and the network/COM interface 308.

The memory 310 may include, but is not limited to, static RAM, dynamic RAM, flash memory, one or more flip-flops, ROM, CD-ROM, DVD, disk, tape, or magnetic, optical, or other computer data storage medium. The memory 310 may include a plurality of program modules 320 and program data 340. The program data 340 stored on the memory 310 may include graph system data 342, configuration data 344, external data 346, predictions 348, and modeling block data 350, which includes cost expression data 352 and constraint expression data 354. The graph system data 342 may include or otherwise define a graph system data structure specifying vertices, edges, and graph layer(s). The graph system data 342 may be generated by the graph UI engine 322 based on static configuration data 344 and/or graph definition data. The vertices, edges, and graph layer(s) may each be associated with a modeling block as included in the modeling block data 350, including cost expression data 352 and constraint expression data 354.

The program modules 320 may include all or portions of other elements of the controller 300. The program modules 320 may be stored at a non-transitive memory of the controller 300. The program modules 320 may run multiple operations concurrently or in parallel by or on the one or more processors 304. In some embodiments, portions of the disclosed modules, components, and/or facilities are embodied as executable instructions embodied in hardware or in firmware, or stored on a non-transitory, machine-readable storage medium. The instructions may comprise computer program code that, when executed by a processor and/or computing device, causes a computing system to implement certain processing steps, procedures, and/or operations, as disclosed herein. The modules, components, and/or facilities disclosed herein may be implemented and/or embodied as a driver, a library, an interface, an API, FPGA configuration data, firmware (e.g., stored on an EEPROM), and/or the like. In some embodiments, portions of the modules, components, and/or facilities disclosed herein are embodied as machine components, such as general and/or application-specific devices, including, but not limited to: circuits, integrated circuits, processing components, interface components, hardware controller(s), storage controller(s), programmable hardware, FPGAs, ASICs, and/or the like. Accordingly, the modules disclosed herein may be referred to as controllers, layers, services, engines, facilities, drivers, circuits, and/or the like.

The system memory 310 may also include data 340. The program modules 320 or other modules, may be stored on the system memory 310, for example, as stored program data 340. The stored program data 340 may be organized as one or more databases.

The modules 320 may include a graph user interface (UI) engine 322, an optimization model engine 324, an optimization solver engine 326, and a control engine 328. As can be appreciated, the modules 320 shown in FIG. 3 and described below can be on a single computing device as illustrated, or can be organized in a distributed computing environment. For example, the graph UI engine 322, the optimization model engine 324, and the optimization solver engine 326 may comprise a graph optimization engine that is integrated with a controller as shown in FIG. 2 or that is distinct from and potentially remote from a controller as shown in FIG. 1.

The graph UI engine 322 may generate and present or otherwise provide a UI by which input may be received to generate and/or adjust, revise, or otherwise modify a graph system. The graph UI engine 322, according to some embodiments, may enable the processor 304 to facilitate receiving user input that includes graph definition data and or user input to modify previously received graph definition data (e.g., as static configuration data). In some embodiments, the UI may be a simple command line or other text data entry tool. In other embodiments, the UI may be a graphical UI that provides a visual portrayal or rendering of the graph system, including portrayal of vertices interconnected by edges. The graphical UI may also provide a visual portrayal of graph layers, which will be described more fully below.

The graph UI engine 322 may also facilitate creating or receiving modeling block data 350. Each vertex of the one or more vertices of a graph system and each edge of the one or more edges may be associated with a modeling block that describes a set of associated constraint expressions Ψ and a set of associated cost expressions Ω. The constraint expressions and cost expressions may be for the one or more attributes as pertaining to the associated vertex or edge. Further, each graph layer of a graph system may be associated with a modeling block that describes a set of associated cost expressions Ω for the one or more attributes as pertaining to the graph layer and a set of associated constraint expressions Ψ for the one or more attributes as pertaining to the graph layer. The constraint expressions and cost expressions may be mathematical expressions or other expressions that describe a constraint or cost, respectively, as such pertains to a given attribute of an associated vertex, edge, or graph layer. The graph UI engine 322 can enable the processor 304 to receive and manipulate input to generate a modeling block and/or a constraint expression and/or cost expression thereof. The graph UI engine 322 may also enable the processor 304 to receive and manipulate input to associate a modeling block with a vertex, an edge, or a graph layer. A graph UI engine 322 may enable the processor 304 to generate and deliver a user interface, such as, to the client computing device 314, to guide a user through a sequence of prompts to provide input according to a process to construct or otherwise configure a graph system.

The graph UI engine 322 may, via a user interface, allow a user to define a graph type for a graph layer. To construct the graph layer for the type, the vertices are defined and added to the graph layer. Defining a vertex can include specifying attributes for the vertex and any constraints associated with the attribute. Once all vertices are defined for a graph layer, the edges are defined for the graph layer. Defining an edge can include specifying attributes for the edge and any constraints associated with the attribute. Once all the edges are defined, the edges are added to the graph by connecting the edge to two vertices. This process continues until all graph layers are defined and constructed.

Once all graph layers are defined, the inter-layer edges are defined. An inter-layer edge connects two vertices, two intra-layer edges, or one vertex and one intra-layer edge between two graph layers. Once the inter-layer edges are completely defined, the graph system is complete.

In one embodiment, configuration software of the graph UI engine 322 may automatically create a graph system, combining information from various sources such as site topology (e.g., information of the devices, aggregates, and connections), utility data (e.g., tariffs, demand response), and any user configurable items. Moreover, this process of creating a graph system may also be distributed between various entities or across various platforms. For example, an electrical graph layer may be created by an engineering team, while an associate financial graph layer may be created by an operations team.

The optimization model engine 324 constructs an optimization model from the graph system generated, modified, etc. via interaction(s) with one or more UIs of the graph UI engine 322. Alternatively or in addition, the graph UI engine 322 may employ the optimization model engine 324. The optimization model engine 324 may construct the optimization model to include one or more objective functions. The optimization model engine 324 may construct the optimization model to include the set of associated cost expressions Ω and the set of associated constraint expressions Ψ (if any) of each modeling block associated with each vertex, edge, and/or graph layer. An optimization model can be a minimization or maximization optimization model.

The optimization solver engine 326 may utilize an optimization model to determine values for the controllable output attributes that optimize the optimization model. The optimization solver engine 326 can utilize the optimization model as an objective function (e.g., an overall objective function for the collective system 312) and to optimize the optimization model to determine control values for the control variables to send to control the system 312 (to effectuate a change to the system 312 toward meeting the overall objective for the system 312). Stated otherwise, the processor 304, using the optimization solver engine 326, may determine control values for the control variables that, if used for control, would effectuate a change to the system 312 to optimize or otherwise enhance operation of the system 312.

The optimization solver engine 326 may provide or include an optimization algorithm to identify a set of control values that optimize the optimization model. The optimization algorithm may optimize the optimization model by determining optimal values that optimize the set of associated cost expressions Ω of each modeling block associated with each vertex, edge, and graph layer, in accordance with the set of associated constraint expressions Ψ of each modeling block. The optimal values may be optimal within a threshold. The optimal values may constitute a control plan. The control plan generated by operation of the optimization solver engine 326 may be an initial control plan or recommended control plan that, if used for controlling the system 312, may effectuate a change to the system 312 to optimize or otherwise enhance operation of the system 312.

The control engine 328 can, using a recommended control plan (e.g., an optimal control plan) from the optimization solver engine 326, prepare a dispatch control plan based on the recommended control plan and one or more of process variables, configuration data 344, external data 346, and predictions 348. A recommended or optimal control plan may represent a set of attributes (control attributes) representing an ideal operation of the system 312 to achieve the overall objectives of the system 312 (e.g., an abstract, non-applied set of control attributes). A dispatch control plan originates at the recommended or optimal control plan and applies adjustments thereto based on real-world feedback from the system 312 to initiate adjustments to the operation of the system 312 in order to achieve, as nearly as reasonable, the overall objectives of the system 312 under real-world operational conditions in real time or near-real time. The dispatch control plan may be the recommended control plan, in some circumstances. In other circumstances, the control engine 328, may adjust control values of a recommended control plan based on information received through one or more of the process variables, operational configuration data 344, external data 346, and predictions 348, to derive a dispatch control plan.

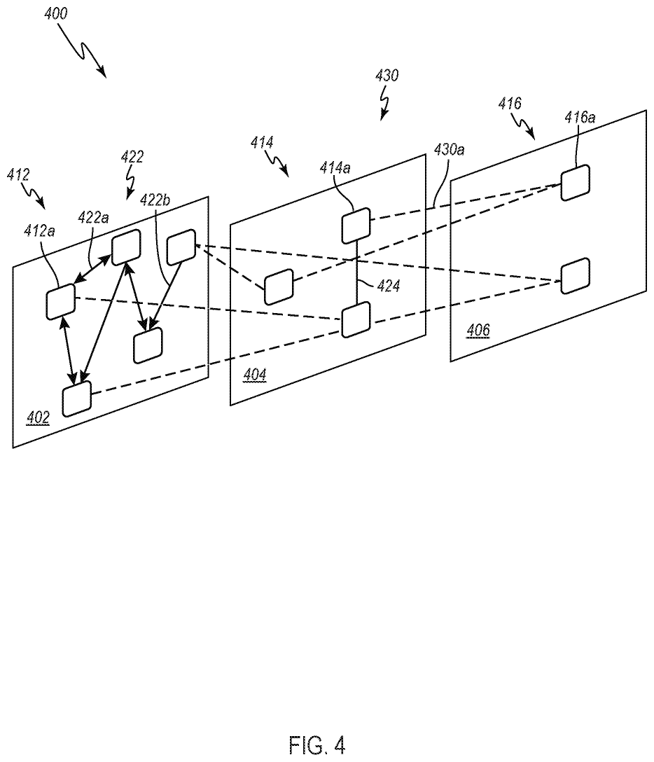

FIG. 4 is a relational diagram of a multi-layered graph system (“graph system”) 400, according to one embodiment of the present disclosure. The graph system 400 represents a complex system, or a system of systems, such asa commercial facility comprising multiple systems. The graph system 400 includes a first graph layer 402, a second graph layer 404, and a third graph layer 406. Each graph layer 402, 404, 406 represents a system of the complex system (or a sub-system of the system) represented by the graph system 400. The first graph layer 402 includes a plurality of vertices 412 that represent entities of a first system (e.g., an electrical system) and a plurality of intra-layer edges 422 that represent flow between entities of the first system. A first vertex 412a is identified for reference. A first intra-layer edge 422a is identified and represents bidirectional flow between entities 412. A second intra-layer 422b is identified and represents unidirectional flow between entities 422. The second graph layer 404 includes vertices 414 that represent entities of a second system (e.g., a thermal system, or a second electrical system) and at least one intra-layer edge 424 (which may unidirectional, bidirectional, or reversible) that represents flow between entities 414 of the second system. A first vertex 414a is identified for reference. The third graph layer 406 includes vertices 416 that represent entities of a third system (e.g., a financial system). A first vertex 416a is identified for reference. The third graph layer 406 does not include intra-layer edges. Entities 416 of the third graph layer 406 have associations or inter-layer edges 430 with entities 412, 414 of the first and second graph layers 402, 404. A first inter-layer edge 430a is identified for reference.

The graph system 400 is a representation of a system to be optimized. The graph system 400 can be composed of one or more graph layers 402, 404, 406, each of which may have one or more objectives and one or more constraints. The objective(s) and constraint(s) may be coupled through the inter-layer edges 430. For instance, electrical and financial graph layers may be coupled to optimize cash flow on the financial graph layer while balancing network power flows on the electrical graph layer. Other examples of multi-layer systems are multi-physics (e.g., electro-mechanical, thermo-electrical), and cyber-physical systems.

The graph layers 402, 404, 406 are each a representation of a network or a system with a characteristic flow. The graph layers 402, 404, 406 may respectively include vertices 412, 414, 416, intra-layer edges 422, 424, and attributes.

Each vertex 412a, 414a, 416a represents an entity which may consume, produce, or store the attribute flowing in the respective graph layer 402, 404, 406. Some examples: an energy storage system (“ESS”) vertex in an electrical graph layer may represent an ESS device which charges, discharges, or stores power in an electrical network; a utility account vertex in a financial graph layer may represent utility charges on a building electrical system which charges (or credits) cash for importing power from/exporting power to the grid; and a reservoir vertex in a hydro graph layer may represent a reservoir device which produces water flow in a hydro network.

Each graph layer 402, 404, 406 may have two kinds of edges: intra-layer edges 422, 424 and inter-layer edges 430. An intra-layer edge 422, 424 represents a conduit through which flow is transported between entities within the given graph layer 402, 404, 406. Examples include: an electrical intra-layer edge may represent an electrical cable which transports power in an electrical network; a financial intra-layer edge may represent a cash transfer mechanism which transports cash in a financial network; a hydro intra-layer edge may represent a pipe which transports water flow in a hydro network. The attribute flow on an intra-layer edge 422, 424 may be unidirectional or bi-directional.

An inter-layer edge 430 represents a coupling of two graph layers 402, 404, 406 within the graph system 400. Examples include: in an electrical-financial graph system, an inter-layer edge may represent a coupling between cash flow in an entity in a financial graph layer with power flow in an entity in an electrical graph layer; in a hydro-electrical graph system, an inter-layer edge may represent a coupling between hydro flow in an entity in a hydro graph layer with power flow in an entity in an electrical graph layer. (A modeling block of an inter-layer edge 430 may reside on either of the graph layers 402, 404, 406 to which the inter-layer edge 430 couples.)

A vertex 412, 414, 416 or edge 422, 424, 430 has one or more attributes. An attribute is a characteristic of a vertex 412, 414, 416, edge 422, 424, 430, or graph layer 402, 404, 406 inherent to the modeling block of the vertex 412, 414, 416, edge 422, 424, 430, or graph layer 402, 404, 406, respectively. An attribute can be either an input attribute or an output attribute. An attribute cannot be categorized as an input attribute and an output attribute simultaneously.

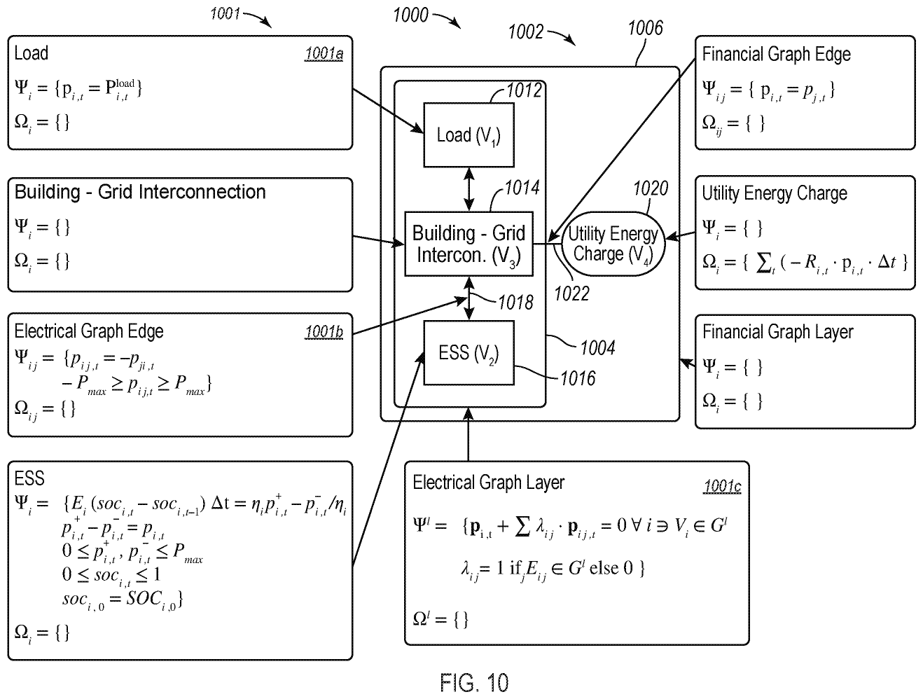

An input attribute represents a characteristic input to the entity's modeling block and is required in order to evaluate the objective(s) and/or constraint(s) within the latter. An input attribute may be: static: for example, the rated energy E₂ of ESS vertex for the graph system shown in FIG. 10; measured: for example, the state of charge (SoC_{2,0}) of ESS vertex for the graph system shown in FIG. 10; forecast: for example, the power P_{1,t} of Load vertex for all time t in the optimization time horizon (e.g., in the graph system shown in FIG. 10 and described below); or calculated: from static, measured, or forecast attributes, such as, electrical power can be derived from measurements of voltage and current. An input attribute that is measured or forecast or calculated from other measured or forecast attributes is inherently not static. An input attribute may be measured and forecast: for example, a power attribute of a load vertex of a graph system may represent both measured and forecast power values.

An output attribute represents a characteristic output of a modeling block after the graph system is optimized, and may be: controlled: controllable attribute corresponds to a variable in the modeling block which is obtained as a solution to the optimization problem (e.g., power p_{2,t} of ESS vertex in the graph system shown in FIG. 10); or diagnostic: diagnostic attribute corresponds to a variable in the modeling block which is a combination of input and/or control attributes. Values for diagnostic attributes can be evaluated after an optimization problem is solved and provide insights into the optimal control plan, objectives, and/or constraints within the modeling block, for example, cost c₄ of Utility Energy Charge vertex, for the graph system shown in FIG. 10. The control values for an aggregate of controllable attributes can form a control plan.

Flow can be defined or otherwise considered as a transport of any attribute between entities (e.g., vertices 412, 414, 416) within a network or system (e.g., a graph layer 402, 404, 406), enabled through some conduit or channel (e.g., represented by or through intra-layer edges 422, 424). Flow may be measurable on a per unit time basis. Examples include: electrical networks enable power flow between entities and the flow attribute is power, which is measured in Watts or J/s; financial networks enable cash (or cost) flow between entities and the flow attribute is cash (or cost), which is measured in $/hour; plumbing networks enable water flow between entities and the flow attribute is water flow, which is measured in gallons per min (gpm) or cubic feet per second (cfs). In a graph system, flow(s) of one or more flow attributes may be supported. A graph layer 402, 404, 406 may support one flow attribute. All intra-layer edges within a graph layer support one and only one flow attribute identical to that of the graph layer. The flow attribute of an inter-layer edge must be identical to one of the flow attributes of either graph layers that the edge connects.

Two or more graph layers 402, 404, 406 may be associated using inter-layer edges 430, as illustrated in FIG. 4. For example, consider that the first graph layer 402 may represent an electrical system and the second graph layer 404 may represent a financial system.

An electrical graph layer is a representation of an electrical network. A vertex in the electrical graph may represent: a device, which can be any physical entity able to consume energy (e.g., electric appliances, lighting, and HVAC installations), generate energy (e.g., solar photovoltaic array or wind turbine), or store energy (e.g., battery); or device aggregates, which may be multiple devices aggregated for convenience, and may consume energy (e.g., apartment or office), generate energy (e.g., solar or wind farm), or store energy (e.g., ESS). Device aggregates may be further aggregated and represented as a vertex on the electrical graph layer. For instance, an apartment complex is an aggregation of apartments, each of which is an aggregate of home appliances. Similarly, a shopping mall is an aggregation of commercial stores, each of which is an aggregation of commercial and lighting equipment. An edge in the electrical graph layer allows for transport of energy through the wiring or connectedness between two devices, two aggregates, or a device and an aggregate.

A financial graph layer can be a graphical representation of the economic operation of the electrical system represented by the foregoing electrical graph layer. A vertex in the financial layer may represent: cost (e.g., demand charge in the utility tariff based on the peak power consumption), incentive (e.g., demand response through which a utility incentivizes site load curtailment during specific time windows), and/or constraint (e.g., a requirement to not export to the electric utility grid). Edges in the financial graph layer may be used for associating financial graph vertices with elements in the electrical graph layer.

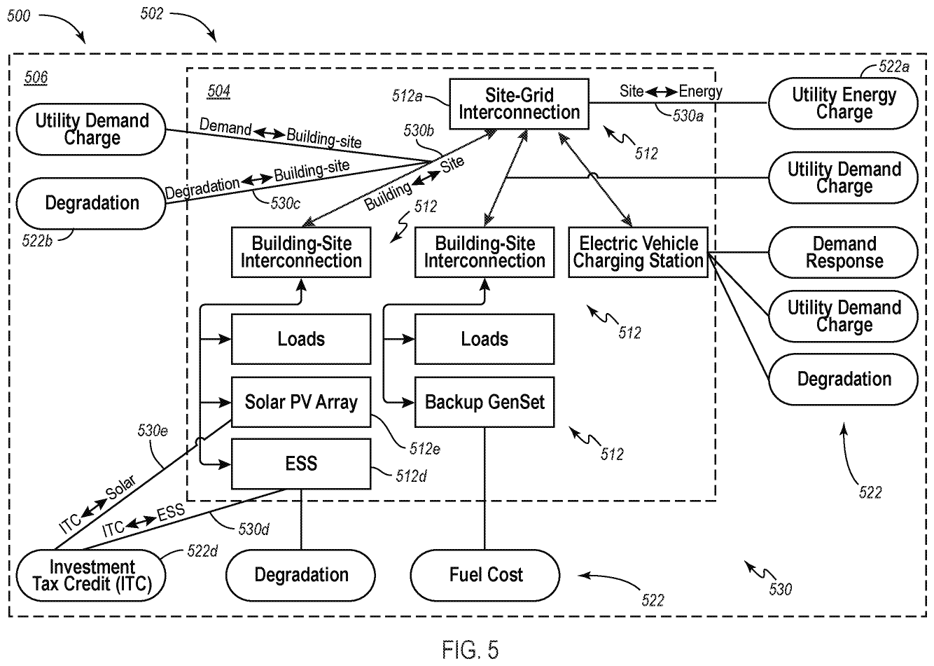

FIG. 5 depicts a graph system 500, according to one embodiment of the present disclosure, for a site electrical system 502 (e.g., a complex system) including an electrical graph layer 504 and a financial graph layer 506. The electrical graph layer 504 and the financial graph layer 506 each includes a plurality of vertices 512, 522, respectively. The graph system 500 includes a plurality of edges, including both intra-layer edges and inter-layer edges. The site electrical system 502 includes a plurality of building electrical systems represented by vertices 512 (e.g., site-grid interconnection vertex 512a, ESS vertex 512d, solar PV array vertex 512e) in the electrical graph layer 504. In the financial graph layer 506, vertices 522 (e.g., the vertices 522a, 522b, 522d), capture or otherwise represent the economic operation of the site based on utility demand and energy charges 522a, incentives from participating in a demand response program, cost of operating the ESS and EVCS, ITCs associated with charging the ESS from renewable energy (solar PV array), and cost of operating the gen-set (fuel cost). Ways in which the financial graph layer 506 may be associated with the electrical graph layer 504 may include: a financial graph vertex associated with an electrical graph vertex through a financial graph edge, such as “Utility Energy Charge” vertex 522a connected to “Site Grid Interconnection” vertex 512a via a “Site↔Energy” edge 530a; a financial graph vertex associated with an electrical graph edge through a financial graph edge, such as “Degradation” vertex 522b connected to “Building↔Site” edge 530b via the “Degradation↔Building-Site” edge 530c; and a financial graph vertex associated with multiple electrical graph vertices through financial graph edges, such as “Investment Tax Credit (ITC)” vertex 522d connected to “ESS” vertex 512d via the “ITC↔ESS” edge 530d and connected to the “solar PV array” vertex 512e via the “ITC↔Solar” edge 530e.

Note that the “degradation” vertex 522b may represent degradation of an electrical graph edge, specifically related to the degradation of the electric cables as they transmit power. Similarly, the graph system 500 may also consider other costs associated with electrical graph edges such as costs associated with transmission loss, ownership, and so on.

The graph system 500 of FIG. 5 represents, without limitation, one of many possible graph system configurations for complex systems, and the present disclosure anticipates similar but different configurations, simpler configurations, smaller configurations, more complex configurations, and larger configurations.

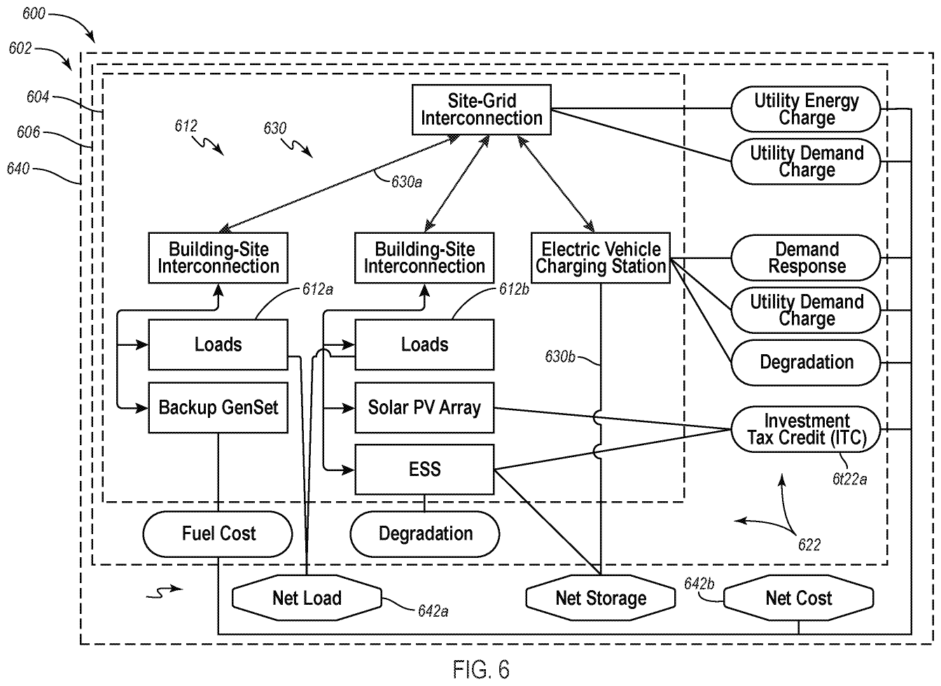

FIG. 6 depicts another graph system 600, according to one embodiment of the present disclosure. The graph system 600 is representative of an electrical system 602 and other systems related thereto. Specifically, the graph system 600 includes a diagnostic graph layer 640, an electrical graph layer 604, and a financial graph layer 606. The graph system 600 may be similar in some respects to the graph system 500 of FIG. 5. The electrical graph layer 604 includes a plurality of electrical graph vertices 612. Two load vertices 612a, 612b are identified as examples of electrical graph layer vertices 612. The financial graph layer 606 includes a plurality of financial graph layer vertices 622. As an example of the financial graph layer vertices 622, an investment tax credit (ITC) vertex 622a is identified. The diagnostic graph layer 640 includes a plurality of diagnostic graph layer vertices 642. A net load vertex 642a and a net cost vertex 642b are identified as examples of diagnostic graph layer vertices 642. The graph system 600 further includes a plurality of edges 630, including intra-layer edges and inter-layer edges. A first intra-layer edge 630a is identified for reference. A first inter-layer edge 630b is also identified for reference. The purpose of the diagnostic graph layer 640 is to aggregate statistics. For instance, the net load vertex 642a captures the aggregate load (the load vertices 612a, 612b) of the building electrical systems, while the net cost vertex 642b captures the net optimal cost of operating the electrical system. Aggregation is enabled via the diagnostic graph edges associating these vertices with the relevant vertices in the other graph layers. Similarly, more graph layers can be easily appended to the graph system as more complexity is added to monitor and control the system.

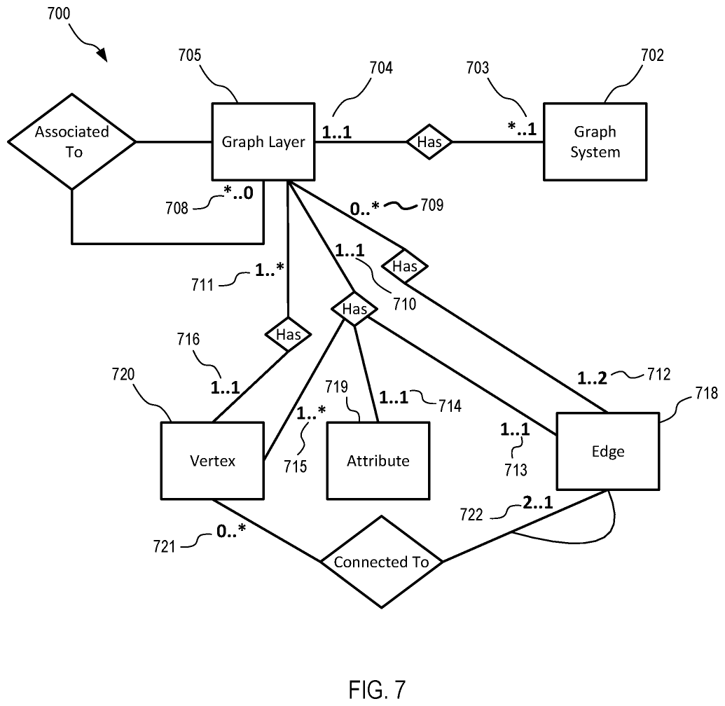

FIG. 7 is a data relationship diagram 700 for a graph system, according to one embodiment of the present disclosure, such as the graph system 500 of FIG. 5, and illustrating a data relationship in the construction of a graph system 702, graph layer 705 and a data relationship to associated graph layers. A graph system 702 can have one-to-many 703 graph layers 705. A graph layer 705 is associated one-to-one 704 with a graph system 702. A graph layer 705 can be associated with zero-to-many 708 other graph layers 705, e.g. via one or more inter-layer edges 718.

The graph layer 705 has 710 one attribute 719 which captures a flow on the graph layer 705, such as a flow of electric power, thermal power, cash, time, etc. (For instance, in FIG. 6 described above, the electrical graph layer 604 captures flow of “electric power,” the financial graph layer 606 represents “money” flows, and the diagnostic layer 640 allows for flow of aggregate attributes.)

A graph layer 705 can be constructed to include one-to-many 711 vertices 720 and zero-to-many 709 edges 718. A single vertex graph layer with no edges can exist, but for the purposes of optimization the system represented by such graph layer would be in a static state and therefore render optimization moot.

Each vertex 720 can have one-to-many 715 attributes 719. Each edge 718 must have 713 one attribute 719, corresponding to the flow attribute of the graph layer 705 if the edge is intra-layer or the flow attribute of one of the two graph layers 705 if the edge is inter-layer.

A vertex 720 may only be associated with 716 one graph layer 705 while an edge 718 may be associated with 712 one graph layers 705, if the edge is intra-layer or two 712 graph layers 705 if the edge is inter-layer. An attribute 719 may not be associated with more than 714 vertex 720, edge 718 or graph layer 705.

Finally, vertices 720 and edges 718 are connected to form associations within and across graph layers. A vertex 720 may be connected to zero-to-many 721 edges 718, while one edge 718 may be connected to (i.e., associated with 722) two elements (i.e. 0-2 two vertices 720 and/or 0-2 edges 718). Examples of an edge connecting to an edge are shown in FIG. 5 (e.g. connection 530c).

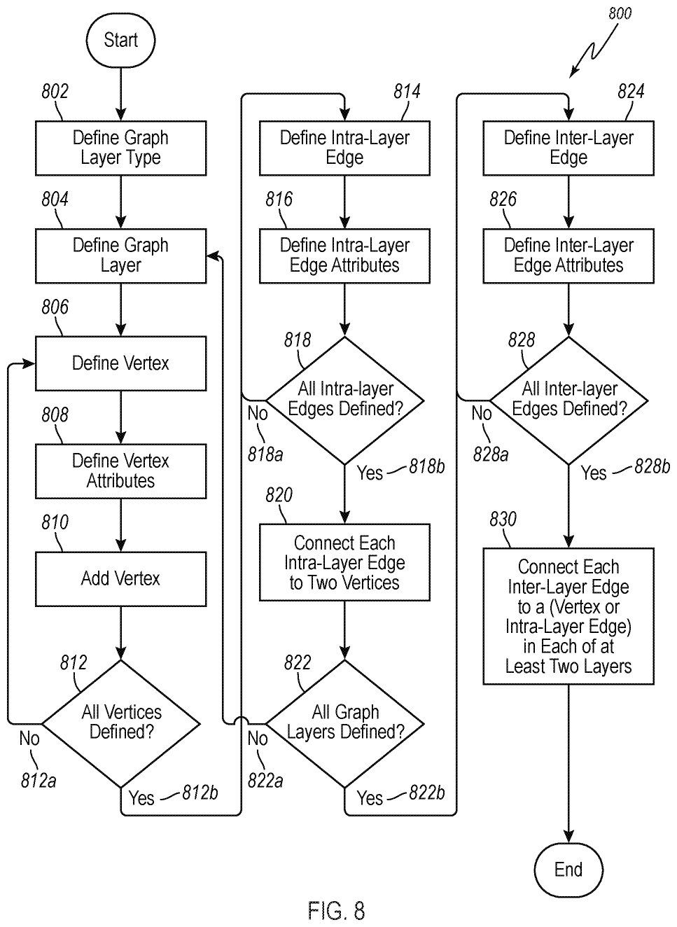

FIG. 8 is a flow diagram of a method 800 to construct a graph system (e.g., the graph system 500 of FIG. 5), according to one embodiment of the present disclosure. The method 800, according to one embodiment, may be implemented or otherwise performed by a controller (e.g., the controller 300 of FIG. 3). The method 800 includes constructing graph layers of the graph system and making associations between the graph layers. A graph layer type is defined. The graph layer type 802 may be defined 802 by input provided by a user, by a controller based on a designation from a user, and/or by the controller based on user input designating a graph type and/or input designating information about a graph system. The method 800 further includes defining 804 a graph layer, or a graph layer is otherwise instantiated and associated with the graph type.

Constructing the graph system includes defining 804 one or more graph layers. At least one vertex is defined 806 for the graph layer. Defining 806 a vertex includes defining 808 at least one attribute for the vertex and any constraint associated with the vertex. The defined vertex is added 810 to the graph layer.

A determination 812 is made whether all vertices for the graph layer are defined. If not 812a, the method 800 iterates to defining 806 a vertex. If yes 812b, at least one intra-layer edge is defined 814 for the graph layer. Defining 814 an intra-layer edge includes defining 816 at least one attribute for each intra-layer edge and any constraint associated with the intra-layer edge.

A determination 818 is made whether all intra-layer edges are defined. If no 818a, the method 800 iterates to defining 814 an intra-layer edge. If yes 818b, the method 800 includes connecting 820 each intra-layer edge to two vertices of the graph layer.

A determination 822 is made whether all graph layers are defined. If no 822a, the method 800 iterates to defining 802 a graph layer. If yes 822b, an inter-layer edge is defined 824. An inter-layer edge connects between two graph layers at a vertex or an intra-layer edge of each of the relevant graph layers. In one embodiment, the inter-layer edge may connect to another inter-layer edge. Attributes of the inter-layer edge are also defined 826. A determination 828 is made whether all inter-edge layers are defined. If no 828a, the method 800 iterates to defining 824 an inter-layer edge. If yes 828b, each inter-layer edge is connected 830 to: vertices of two graph layers; a vertex of one graph layer and an intra-layer edge of another graph layer; intra-graph edges of two graph layers; a vertex or edge of one graph layer and an inter-layer edge related to at least one other graph layer.

A graph system may be created according to the method 800 by users directly utilizing an interface or by configuration software which can automatically create the graph system by combining information from various sources such as static configuration data and/or graph definition data (e.g., information of the devices, aggregates, and connections), utility data (e.g., tariffs, demand response), and any user configurable items. This process of creation may also collect information distributed between various entities or across various platforms. For example, for the graph system depicted in FIG. 5, the electrical graph layer may be created by an engineering team, while a financial graph layer may be created by the operation team (see the electrical graph layer 504 and the financial graph layer 506 in FIG. 5).

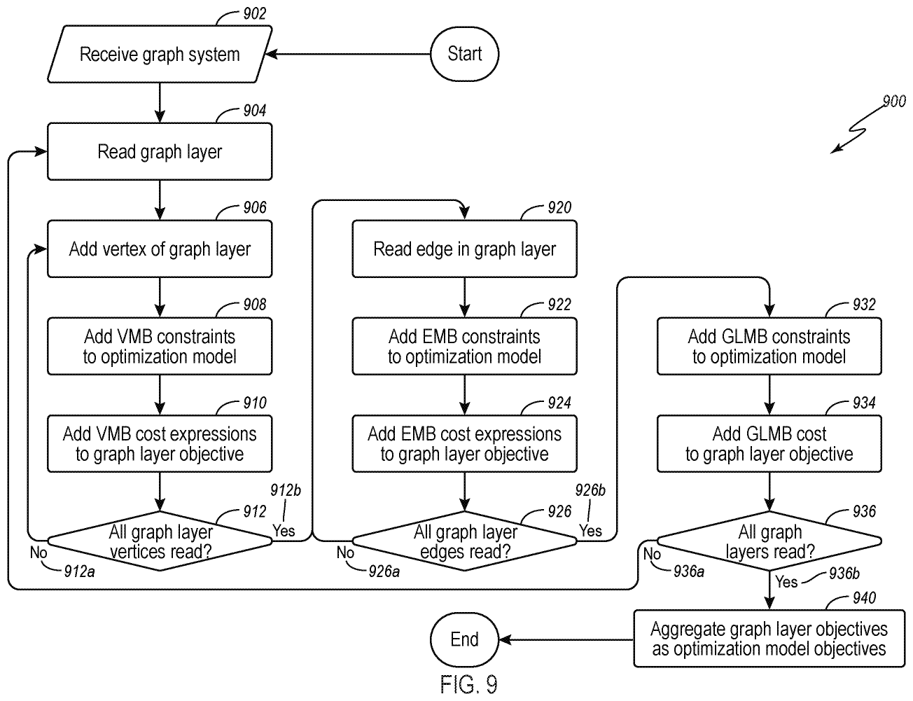

FIG. 9 is a flow diagram of a method 900 to construct an optimization model utilizing a graph system (e.g., the graph system 500 of FIG. 5), according to one embodiment of the present disclosure. The method 900, according to one embodiment, may be implemented or otherwise performed by a controller (e.g., the controller 300 of FIG. 3). A graph system is received 902. The graph system may be generated by or otherwise processed at graph UI engine, such as, the graph UI engine 322 of FIG. 3. The graph system may be generated according to a method of graph construction, such as the method 800 of FIG. 8. The graph system can include a data structure of vertices, edges, and graph layers that represents a system to be optimized. Every vertex, edge, and graph layer can correspond to a modeling block. Each modeling block describes a set of associated constraint expressions Ψ and/or cost expressions Ω. The data structure of the graph system is traversed as follows to aggregate or otherwise incorporate cost expressions and constraint expressions into an optimization model.

A graph layer of the received graph system is read 904, which can include identifying one or more of a graph layer type, an association of one or more vertices and edges of the graph layer, and/or a modeling block (vertex modeling block—hereafter “VMB”) of the graph layer. A vertex of the graph layer is added 906, which can include identifying a VMB. The controller adds 908 any VMB constraint expressions for the vertex to the optimization model being constructed. The VMB cost expressions of the vertex are added 910 to a graph layer objective (e.g., an objective function for the graph layer).

A determination 912 is made whether all graph layer vertices have been read. If no 912a, the controller iterates from adding 906 a vertex until all vertices are processed. If yes 912b, an edge in the graph layer is read 920, which can include identifying a modelling block of the edge (edge modelling block—hereafter, “EMB”). Any EMB constraint expressions are added 922 to the optimization model being constructed. The EMB cost expressions are added 924 to the graph layer objective.

A determination 926 is made whether all the graph layer edges have been read. If no 926a, the method 900 iterates from reading 920 an edge in the graph layer. As noted previously, each edge can be an intra-layer edge or inter-layer edge. An inter-layer edge can be included in the data structure with either graph layer to which it connects. In some embodiments, a check may be performed to ensure an intra-layer edge resides in only a single graph layer or to ensure an inter-layer edge is read only once in the method 900. If yes 926b, the graph layer as a whole is processed.

A graph layer can include or otherwise be associated with a modeling block (graph layer modeling block—hereafter “GLMB”) that has constraint expressions and cost expressions for the graph layer (e.g., for a network or system as a whole). The GLMB can be identified when the graph layer is read 904. The GLMB constraint expressions can be added 932 to the optimization model being constructed. The GLMB cost expressions can also be added 934 to the graph layer objective of the optimization model being constructed.

A determination 936 is made whether all graph layers of the graph system have been read. If no 936a, the method 900 iterates from reading 904 a graph layer of the graph system. If yes 936b, the graph layer objectives (e.g., graph layer objective functions) are aggregated 940 together as an optimization model objective or overall objective of the optimization model being constructed.

For a cost minimization optimization problem, the optimization model is constructed from the following equations:

$$min ( {f}^{1} ( x ) , {f}^{2} ( x ) , {f}^{3} ( x ) … {f}^{L} ( x ) ) \qquad 1$$

$$s . t . {Ψ}^{l} ( x ) for I = 1 , 2 , 3 … L \qquad 2$$

$$s . t . {⋃}_{{V}_{i} ∈ {G}^{l}} {Ψ}_{i} ( x ) for I = 1 , 2 , 3 … L \qquad 3$$

$$s . t . {⋃}_{{E}_{i j} ∈ {G}^{l}} {Ψ}_{i j} ( x ) for I = 1 , 2 , 3 … L \qquad 4$$

$$where {f}^{l} ( x ) = {Ω}^{l} ( x ) + {\sum }_{{V}_{i} ∈ {G}^{l}} {Ω}_{i} ( x ) + {\sum }_{{E}_{i j} ∈ {G}^{l}} {Ω}_{i j} ( x ) for I = 1 , 2 , 3 … L \qquad 5$$

Equation 1 represents an optimization model with up to L objectives (e.g., objective functions of individual graph layers). The objective of graph layer G^{l}, f^{l}(x) is described in Equation 5, and is the aggregate of cost expressions corresponding to (a) the graph layer G^{l} (first term), (b) vertices constituting G^{l} (second term), and (c) edges constituting G^{l} (third term). This optimization model is subject to the constraints corresponding to all graph layers (Equation 2), all vertices (Equation 3), and all edges (Equation 4).

FIG. 10 is a diagram depicting associations for a graph system 1000, according to one embodiment of the present disclosure, associating modeling blocks 1001 to elements 1002 of the graph system 1000. The modeling blocks 1001 may be used to construct of an optimization model for the graph system 1000. A modeling block 1001 describes a set of associated constraint expressions Ψ and/or cost expressions Ω. A modeling block 1001a for a vertex Vᵢ (e.g., vertex Load (V₁)) 1012 mathematically describes the set of associated constraint expressions Ψᵢ and cost expressions Ωᵢ. A modeling block 1001b for an edge Eᵢⱼ (e.g., edge V₂-V₃ 1018) connecting vertices Vᵢ and Vⱼ mathematically describes the set of associated constraint expressions Ψᵢⱼ and cost expressions Ωᵢⱼ. A modeling block 1001c for graph layer G^{l} (e.g., Electrical Graph Layer 1004) mathematically describes the set of constraint expressions Ψ^{l} and cost expressions Ω^{l}. Expressions in Ψ and Ω may include (a) input attributes, (b) output attributes which are solved for as part of the optimization problem, and (c) internal variables which are neither input nor output attributes. A subset x of the output attributes are controllable and collectively refer to the control plan. For sake of clarity herein, input attributes are typically denoted in capital letters (e.g., load forecast P or utility energy rate E), while the other variables (e.g., attributes) are denoted using lower case letters (e.g., ESS power p_{2,t}).

The graph system 1000 includes an electrical graph layer 1004 (representing a building electrical system) and a financial graph layer 1006 (representing operating costs). As described in the previous paragraph, every vertex implements (e.g., is associated with a modeling block that includes) its constraint expressions and/or cost expressions. For instance, for the ESS 1016, a set of constraint expressions Ψᵢ includes expressions that relate the change in SoC to the rated energy (E), efficiency (η), and power charged or discharged (p) at any time t. The Utility Energy Charge vertex 1020 does not impose any constraints, i.e., Ψᵢ is an empty set, but implements a cost expression Di which relates the power imported from/exported to the grid with the energy rate applicable at the time. Meanwhile, the Utility Demand Charge vertex (not shown) implements both constraints and cost expressions. The constraints account for power imported from the grid only, and apply when the demand rate is active (i.e., D>0), while the cost expression relates the imported power with the demand rate. The ESS degradation cost is proportional to the cycling of ESS.

Similarly, every edge implements its constraint expressions and cost expressions. An electrical graph edge V₂-V₃ 1018, which connects two electrical graph vertices V₂ 1014 and V₃ 1016, includes constraint expressions that constrain the power flow to be equal and opposite. For instance, power flow from ESS 1016 to Building-Site-Interconnection 1014 is equal and opposite in sign compared to power flow from Building-Site-Interconnection 1014 to ESS 1016 at any time. Similarly, a financial graph intra-layer edge V₃-V₄ 1022 constrains the cost flow to be equal and opposite between two graph vertices V₃ 1014 and V₄ 1020. The financial graph inter-layer edge 1022, which connects a financial graph vertex to a physical graph vertex or edge, can help guarantee equality of power. In the graph system 1000, the presence of the Financial Graph Edge 1022 connecting the Utility Energy Charge vertex 1020 to the Building-Grid-Interconnection vertex 1014 ensures that the power flow through the latter is used for evaluating the cost expression in the former.

Finally, every graph system may implement cost and constraint expressions. For instance, the electrical graph layer 1004 may impose power balance constraint at every vertex belonging to the graph layer (i.e., the power in any vertex Vᵢ at any time t must equal the net power flow into Vᵢ from all the edges connected to vertex Vᵢ.).

In the graph system 1000, the overall optimization model can be written as (Tables 1 and 2, below, respectively identify common symbols and common sub- and superscripts):

$$min {\sum }_{r}^{Γ} - {R}_{4 , t} . {p}_{4 , t} . Δ t + {\hat{D}}_{5} . {\hat{p}}_{5} + {\sum }_{r}^{Γ} {C}_{6} . {p}_{6 , t} . Δ t \qquad 6$$

subject to all vertex constraints:

$$\begin{matrix}\begin{matrix}{p}_{1 , t} = {P}_{1 , t}^{l o a d} & ∀ t ∈ Γ\end{matrix} \\ \begin{matrix}{E}_{2} ( s o {c}_{2 , t} - s o {c}_{2 , t - 1} ) Δ t = {η}_{2} {p}_{2 , t}^{+} - \frac{{p}_{2 , t}^{-}}{{η}_{2}} & ∀ t ∈ Γ\end{matrix} \\ \begin{matrix}{p}_{2 , t} = {p}_{2 , t}^{+} - {p}_{2 , t}^{-} & ∀ t ∈ Γ\end{matrix} \\ \begin{matrix}0 \leq {p}_{2 , t}^{+} , {p}_{2 , t}^{+} \leq {P}_{2 , max} & ∀ t ∈ Γ\end{matrix} \\ \begin{matrix}0 \leq so {c}_{2 , t} \leq 1 & ∀ t ∈ Γ\end{matrix} \\ so {c}_{2 , 0} = {SOC}_{2 , 0} \\ \begin{matrix}{p}_{5 , \hat{t}} = {\tilde{p}}_{5 , \hat{t}} - {\hat{p}}_{5} & ∀ \hat{t} ∈ Γ\end{matrix} \\ \begin{matrix}{\tilde{p}}_{5 , \hat{t}} , {\hat{p}}_{5} \geq 0 & ∀ \hat{t} ∈ Γ\end{matrix} \\ \hat{t} ∈ Γ s . t . {D}_{5 , \hat{t}} > 0 \\ {\tilde{D}}_{5} \geq {D}_{5 , \hat{t}}\end{matrix} \qquad 7$$

subject to all edge constraints:

$$\begin{matrix}\begin{matrix}{p}_{13 , t} = - {p}_{31 , t} & ∀ t ∈ Γ\end{matrix} \\ \begin{matrix}{p}_{12 , t} = - {p}_{21 , t} & ∀ t ∈ Γ\end{matrix} \\ \begin{matrix}{p}_{4 , t} = {p}_{3 , t} & ∀ t ∈ Γ\end{matrix} \\ \begin{matrix}{p}_{5 , t} = {p}_{3 , t} & ∀ t ∈ Γ\end{matrix} \\ \begin{matrix}{p}_{6 , t} = {p}_{2 , t} & ∀ t ∈ Γ\end{matrix}\end{matrix} \qquad 8$$

subject to all graph layer constraints:

$$\begin{matrix}\begin{matrix}{P}_{1 , t} + {P}_{31 , t} = 0 & ∀ t ∈ Γ\end{matrix} \\ \begin{matrix}{p}_{2 , t} + {p}_{23 , t} = 0 & ∀ t ∈ Γ\end{matrix} \\ \begin{matrix}{P}_{3 , t} + {p}_{31 , t} + {p}_{32 , t} = 0 & ∀ t ∈ Γ\end{matrix}\end{matrix} \qquad 9$$

TABLE 1
Common symbols

| | |
|---|---|
| Ψ | set of constraints |
| Ω | cost (or profit) expression |
| f | objective |
| V | vertex |
| E | edge |
| G | graph layer |
| x | set of controllable attributes |
| Γ | optimization time horizon |
| p | power |
| c | cost |
| R | energy consumption rate |
| Ess | ESS rated energy |
| soc | ESS state of charge |
| η | ESS efficiency |

Common subscripts and superscripts

| | |
|---|---|
| t | time index |
| l | graph layer index |
| i | vertex index |
| ij | edge index |

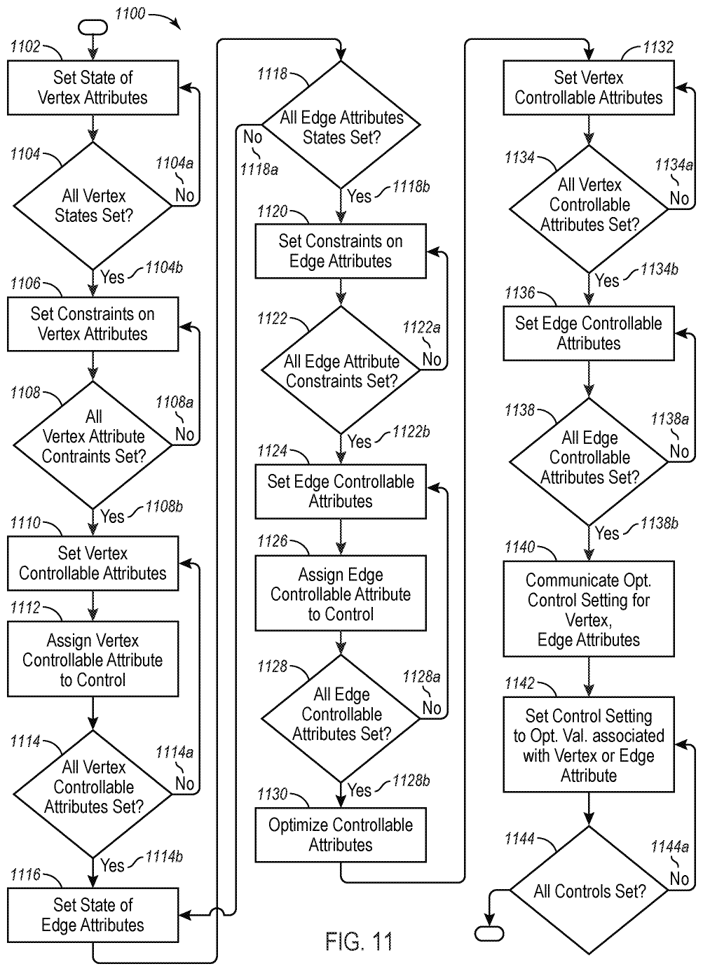

FIG. 11 is a flow diagram for a method 1100 to optimize an optimization model for a graph system, according to one embodiment of the present disclosure. The method 1100 may, in some embodiments, be implemented or otherwise performed by an optimization model engine and optimization model solver (e.g., the optimization model engine 324 and the optimization model solver 326 of FIG. 3, (hereafter, “OME/S”)) to optimize an optimization model for a graph system, such as, the graph system 500 of FIG. 5. The flow diagram itself is first described, and then further explained thereafter. A state of vertex attributes is set 1102. A determination 1104 is made 1104 whether all vertex states have been set. If no 1104a, the method 1100 iterates from setting 1102 a state of vertex attributes. If no 1104b, constraints on a vertex attribute are set 1106. A determination 1108 is made whether all vertex attribute constraints are set. If no 1108a, the method 1100 iterates from setting 1106 constraints on vertex attributes. If yes 1108b, vertex controllable attributes are set 1110. A vertex controllable attribute to control is assigned 1112. A determination is made 1114 whether all vertex controllable attributes are set. If no 1114a, the method 1100 iterates from setting 1110 vertex controllable attributes. If yes 1114b, a state of edge attributes is set 1116. A determination is made 1118 whether all edge attributes states are set. If no 1118a, the method 1100 iterates from setting 1116 state of edge attributes. If yes 1118b, constraints on edge attributes are set 1120. A determination is made 1122 whether all edge attribute constraints are set. If no 1122a, the method 1100 iterates from setting 1120 constraints on edge attributes. If yes 1122b, edge controllable attributes are set 1124. An edge controllable attribute to control is assigned 1126. A determination is made 1128 whether all edge controllable attributes are set. If no 1128a, the method 1100 iterates from setting 1124 edge controllable attributes. If yes 1128b, controllable attributes are optimized. Vertex controllable attributes are set 1132. A determination is made 1134 whether all vertex controllable attributes are set. If no 1134a, the method 1100 iterates from setting 1132 vertex controllable attributes. If yes 1134b, edge controllable attributes are set 1136. A determination 1138 is made whether all edge controllable attributes are set. If no 1138a, the method 1100 iterates from setting 1136 edge controllable attributes. If yes 1138b, an optimal control setting for a vertex or edge attribute is communicated 1140 (e.g., to a controller). A control setting is set 1142 (e.g., by the controller) to an optimal value associated with the vertex of edge attribute. A determination is made 1144 (e.g., by the OME/S and/or the controller) whether all controls are set. If no 1144a, the method 1100 iterates from setting 1142 a control setting to an optimal value associated with a vertex or edge attribute.

The method 1100 may be performed by an optimization solver engine, according to embodiments of the present disclosure. Input attributes of all vertices in the graph system can be updated with time-series values. Time-series values are a collection of timestamp and value pairs. Next, input attributes of all edges in the graph system can be updated with time series values. Subsequently, modeling blocks in the graph system are updated with relevant input attributes. The optimization model for the graph system is then solved using Equations 1-5. Output attributes—both control and diagnostic—are obtained as outputs from the modeling block as time-series values. The aggregate of control attributes constitutes the control plan.

For the optimization problem described in Equations 6-9, the input attributes of vertices are first updated. These are:
A1: power attribute P_{1,t} of the Load vertex
A2: energy rating attribute E₂ of the ESS vertex
A3: efficiency attribute η₂ of the ESS vertex
A4: initial SoC attribute SOC_{2,0} of the ESS vertex
A5: energy rate attribute R_{4,t} of the Utility Energy Charge vertex V₄
A6: energy rate attribute R_{5,t} of the Utility Energy Charge vertex V₅
A7: discharge-based coefficient of degradation C₀ of the Degradation vertex

All input attributes are updated with timeseries values. Some of these attributes may be forecast (e.g., A1, A5, A6), some may be measured or derived (e.g., A3, A4), while others may be static (e.g., A2, A7). Attributes that are forecast have time-series values that span the optimization time horizon Γ. An example of time-series values comprising of four timestamp-value pairs for A1 is:
(04/20/2021 00:00:00, 100 kW),
(04/20/2021 01:00:00, 110 kW),
(04/20/2021 02:00:00, 115 kW),
(04/20/2021 03:00:00, 110 kW)

Next, input attributes of edges are updated. These are:
A8: power rating attribute P_{13,max} of edge which connects V₁ and V₃
A9: power rating attribute P_{23,max} of edge which connects V₂ and V₃

Modeling blocks of all the vertices and graph layers are subsequently updated with time-series values of all input attributes. The optimization model represented by Equations 6-14 is solved and values for the control attributes are set. These are:
A10: power attribute P_{2,t} of the ESS
   In this example, time-series values of A10 represent the control plan.

Similar to graph construction and construction of the optimization model, the process for graph system optimization may be distributed. As such each of these processes may be performed on a different processor(s):
graph system configuration (may be further distributed among processors);
update to attribute values (may be further distributed among processors);
update to modeling blocks; and
solving the optimization problem.

In some embodiments, an optimization solver engine uses an algorithm (e.g., an optimization algorithm) to determine optimal (e.g., within a threshold degree of optimal) control values for control attributes, for example, to improve performance of the electrical system. Optimization can be a process of finding the value(s) of the variable(s) (e.g., control attribute(s)) at which the optimization model is minimized or maximized. An optimization may be made with reference to such global extrema (e.g., global maximums and/or minimums), or even local extrema (e.g., local maximums and/or minimums). Given that an algorithm that finds a minimum of a function can generally also find a maximum of the same function by negating it, the present disclosure can sometimes use the terms “minimization,” “maximization,” and “optimization,” interchangeably.

An objective of optimization may be economic optimization, or determining economically optimal values for control variables to effectuate one or more changes to the electrical system to achieve economic efficiency (e.g., to operate the electrical system at as low a cost as may be possible, given the circumstances). As can be appreciated, other objectives may be possible as well (e.g., prolong equipment life, system reliability, system availability, fuel consumption). Various forms of optimization may be utilized to economically optimize an electrical system including, but not limited to: continuous optimization, constrained optimization, generalized optimization, nonlinear optimization, and multi-variable optimization, integer optimization, discrete optimization, combinatorial optimization, mixed-integer linear optimization, mixed-integer nonlinear optimization, stochastic optimization.

In some embodiments, optimizing the optimization model may determine control values for a set of control attributes as a recommended control plan to provide to a system to effectuate a change to the system toward meeting the overall objective for the system during an upcoming time domain. For example, an optimization solver engine may determine recommended control values for a recommended control plan, where the control values, if used for control, would effectuate a change to the electrical system toward the overall objective. The level of effectiveness of actual use of the recommended control plan may depend on the actual state of the system (e.g., feedback via process variables), operational configuration, accuracy of predictions or forecasts used in optimizing the optimization model, and/or other factors (e.g., external factors) included in external inputs.

In some embodiments, the optimization solver engine can determine values for a set of control parameters, which are then used (e.g., such as by another component or process) to determine control values for control variables to be communicated to a system to be controlled. For example, a controller may include an optimizer and a high-speed controller. The optimizer may include the optimization solver engine. The optimizer may provide control parameters to the high-speed controller, which may then process the control parameters to generate and provide the control variables directly to the system.

While the graph systems shown in the figures and described herein include certain numbers and types of graph layers, the present disclosure anticipates, and the technology described herein can handle, any number and type of graph layers. For instance, while the graph system 600 of FIG. 6 includes addition of a diagnostic graph layer to a graph system similar to the graph system 500 of FIG. 5, the present disclosure anticipates other graph layer additions. As one example, for an entity having a plurality of disparate locations consuming (and possibly generating) electrical power, a graph system may include a plurality of electrical graph layers, and may further include an aggregating electrical graph layer. A computer server graph layer may be employed to optimize, adjust, or otherwise modify computer server services, etc. A graph system according to an embodiment of the present disclosure may have a weather graph layer and employ weather forecast modeling to anticipate and respond to impacts of weather on a physical system to which the graph system is applied, such as, to modify route selection for cross-country delivery systems, to anticipate impacts on regional power systems due to weather, etc. The present disclosure further anticipates a graph system functioning in an artificial intelligence or machine-learning mode (AI/MLM). By way of example without limitation, a graph system may be used to generate, adjust, modify, or otherwise interact with a graph system of an entity, such as, to add a computer server graph layer (and other related graph layers) when a company moves from exclusively renting/leasing computer server services to operating a computer server farm; to removing one or more graph layers when a company disposes of, for example, a light truck fleet; to expand and/or contract a graph layer in response to entity changes, such as, updating an office building from a simple incandescent/fluorescent lighting system to a “smart” LED-based lighting system; to replace (a) formula/formula of a graph layer with (an)other formula/formula as may be appropriate under a variety of conditions or circumstances; etc.

### EXAMPLES

Some examples of embodiments of the present disclosure are now provided.

Example 1. A controller to control operation of a system, comprising: a communication interface to connect to a communication path to one or more controllable elements of a system; a memory to store a graph system comprising one or more vertices and one or more edges, each vertex of the one or more vertices representing an entity in the system that includes one or more attributes, each edge of the one or more edges representing a flow of an attribute with respect to at least one entity in the system, wherein each vertex of the one or more vertices and each edge of the one or more edges is associated with a modeling block that describes a set of associated constraint expressions Ψ and a set of associated cost expressions Ω for the one or more attributes (as pertaining to the associated vertex or edge); and one or more processors to: construct an optimization model from the graph system, the optimization model including one or more objective functions and constructed to include the set of associated cost expressions Ω and the set of associated constraint expressions Ψ (see Example 5) of each modeling block associated with each vertex of the one or more vertices and each edge of the one or more edges according to the graph system; determine a set of control values for a set of controllable output attributes (e.g., control variables) of the one or more attributes, the set of control values to effectuate a change to the system for enhancing operation of the system, wherein the set of control values are determined by the one or more processors utilizing an optimization algorithm (to identify the set of control values that optimize the optimization model); and provide the set of control values for the set of controllable output attributes (e.g., control variables) to the one or more controllable elements of the system via the communication interface to control operation of the system.

Example 2. The controller of example 1, wherein the graph system further comprises one or more graph layers each comprising one or more of the one or more vertices and one or more intra-layer edges of the one or more edges, wherein each graph layer supports one, and only one flow of an attribute, and wherein each intra-layer edge represents the flow of the attribute with respect to at least one vertex (e.g., entity) within the graph layer; wherein each graph layer is associated with a modeling block that describes a set of associated cost expressions Ω for the one or more attributes (as pertaining to the associated graph layer (i.e., the flow of the attribute is supported by the associated graph layer and one or more intra-layer edges therein), and a set of associate constraint expressions Ψ, and wherein the one or more processors construct the optimization model from the graph system further to include the set of associated cost expressions Ω of each modeling block associated with each graph layer, and wherein the overall objective is not a simple aggregation of all the cost expressions Ψ of all the modeling blocks.

Example 3. The controller of example 2, wherein each graph layer comprises a graph layer objective that is represented by a graph layer objective function that is an aggregation of the associated cost expressions Ω for the one or more attributes, as pertaining to the associated graph layer, wherein the one or more processors construct the optimization model from the graph system to include the one or more graph layer objective functions corresponding to the one or more graph layers, wherein the set of control values are determined by the one or more processors utilizing an optimization algorithm to identify the set of control values that optimize the optimization model that includes the one or more graph layer objective functions corresponding to the one or more graph layers.

Example 4. The controller of example 2, wherein each graph layer of the one or more graph layers is associated with an objective.

Example 5. The controller of example 2, wherein the optimization model is potentially composed of multiple objectives which the controller must solve simultaneously (or in parallel), such as, in a thermo-electrical system, the optimization model may be solved by maximizing comfort (as objective 1) while minimizing operating cost (as objective 2).

Example 6. The controller of example 2, wherein the graph system further comprises one or more inter-layer edges extending between a first graph layer and a second graph layer of the one or more graph layers, each inter-layer edge of the one or more inter-layer edges representing a flow of the attribute identical to the flow attribute of one of the first graph layer and second graph layer.

Example 7. The controller of example 6, wherein the system is a complex system encompassing multiple discrete systems each having a different flow attribute, wherein each graph layer is representative of a discrete system of the multiple discrete systems, wherein an inter-layer edge represents a relation between a first discrete system represented by the first graph layer and a second discrete system represented by the second graph layer, and wherein the controllable elements of the system are included one of the first discrete system and the second discrete system.

Example 7. The controller of example 6, wherein the controllable elements of the system are included in a physical system and the physical system is one the first discrete system and the second discrete system.

Example 8. The controller of example 6, wherein at least one of the multiple discrete systems is a physical system including the controllable elements.

Example 9. The controller of example 1, wherein the optimization model is subject to the set of associated constraint expressions Ψ of each modeling block associated with each vertex of the one or more vertices and each edge of the one or more edges according to the graph system.

Example 10. The controller of example 1, wherein the set of control values are determined by the one or more processors utilizing the optimization algorithm to identify the set of control values that optimize the optimization model, and particularly that optimize the set of associated cost expressions Ω of each modeling block associated with each vertex of the one or more vertices and each edge of the one or more edges, in accordance with the set of associated constraint expressions Ψ of each modeling block associated with each vertex of the one or more vertices an each edge of the one or more edges.

Example 11. The controller of example 1, wherein the one or more processers are further to: receive graph definition data; and generate the graph system in the memory based on the graph definition data.

Example 12. The controller of example 11, wherein the one or more processors are further to provide a graphical user interface for a user to input the graph definition data.

Example 13. The controller of example 12, wherein the graphical user interface provides a visual graphical representation of the graph system, including the one or more vertices and the one or more edges.

Example 14. The controller of example 1, wherein each attribute is a characteristic of one or more of a vertex, an edge, and a graph layer, the characteristic being inherent to the associated modeling block, and wherein each attribute is one of an input attribute and an output attribute, an input attribute representing a characteristic input to a modeling block and an output attribute representing a characteristic output from a modeling block, and wherein each output attribute is one of a diagnostic output attribute and controllable output attribute.

Example 15. The controller of example 14, wherein each input attribute is either static or able to be at least one of measured, forecasted, and calculated.

Example 16. The controller of example 1, wherein the one or more processors comprise: a first processor to construct the optimization model from the graph system; and a second processor to determine the set of control values for the set of controllable output attributes.

Example 17. The controller of example 1, wherein the one or more processors comprise a plurality of processors each arranged remote from other of the plurality of processors in a distributed computing paradigm, wherein a first processor of the plurality of processors constructs the optimization model and a second processor of the plurality of processors determines the set of control values.

Example 18. The controller of example 17, wherein the system comprises an electrical system.

Example 19. The controller of example 17, wherein the system comprises a thermo-electrical system.

Example 20. A method (e.g., of a controller) to control operation of a system, the method comprising: receiving graph definition data; generating a graph system based on the graph definition data, the graph system comprising one or more vertices and one or more edges, each vertex of the one or more vertices representing an entity in the system that includes one or attributes, each edge of the one or more edges representing a flow of an attribute with respect to at least one entity in the system, wherein each vertex of the one or more vertices and each edge of the one or more edges is associated with a modeling block that describes a set of associated constraint expressions Ψ and a set of associated cost expressions Ω for the one or more attributes as pertaining to the associated vertex or edge; constructing an optimization model from the graph system, the optimization model including one or more objective functions and constructed to include the set of associated constraint expressions Ψ and the set of associated cost expressions Ω of each modeling block associated with each vertex of the one or more vertices and each edge of the one or more edges according to the graph system; determine a set of control values for a set of controllable output attributes (e.g., control variables), of the one or more attributes, the set of control values to effectuate a change to the system for enhancing operation of the system, wherein the set of control values is determined utilizing an optimization algorithm to identify the set of control values that optimize the optimization model; and providing the set of control values for the set of controllable output attributes to one or more controllable elements of the system via a communication interface to control operation of the system.

Example 21. The method of example 20, wherein the graph system further comprises one or more graph layers each comprising one or more the one or more vertices and one or more of the one or more edges, wherein each graph layer supports one, and only one flow of an attribute, and each intra-layer edge represents the flow of the attribute with respect to at least one vertex (e.g., entity) within the graph layer; wherein each graph layer is associated with a modeling block that describes a set of associated cost expressions Ω for the one or more attributes as pertaining to the associated graph layer (i.e., the flow of the attribute is supported by the associated graph layer and the one or more intra-layer edges therein) and a set of associated constraint expressions Ψ, and wherein constructing the optimization model from the graph system includes the set of associated cost expressions Ω of each modeling block associated with each graph layer.

Example 22. The method example 21, wherein each graph layer comprises a graph layer objective that is represented by a graph layer objective function that is an aggregation the associated cost expressions Ω for the one or more attributes as pertaining to the associated graph layer, wherein constructing the optimization model from the graph system includes the one or more graph layer objective functions corresponding to the one or more graph layers, wherein the set of control values are determined utilizing an optimization algorithm to identify the set of control values that optimize the optimization model that includes the one or more graph layer objective functions corresponding to the one or more graph layers.

Example 23. The method of example 21, wherein each graph layer of the one or more graph layers is associated with an objective.

Example 24. The method of example 21, wherein the graph system further comprises one or more inter-layer edges extending between a first graph layer and a second graph layer of the one or more graph layers, each inter-layer edge of the one or more inter-layer edges representing a flow of the attribute identical to the flow attribute of one of the first graph layer and the second graph layer.

Example 25. The method of example 24, wherein the system is a complex system encompassing multiple discrete system each having a different flow attribute, wherein each graph layer is representative of a discrete system of the multiple discrete systems, wherein an inter-layer edge represents a relation between a first discrete system represented by the first graph layer and a second discrete system represented by a second graph layer, and wherein the controllable elements of the system are included in one of the first discrete system and the second discrete system.

Example 26. The method of example 25, wherein the one or more controllable elements of the system are included in a physical system and the physical system is one of the first discrete system and the second discrete system.

Example 27. The method of example 25, wherein at least one of the multiple discrete systems is a physical system including the controllable elements.

Example 28. The method of example 20, wherein the optimization model includes or is otherwise subject to the set of associated constraint expressions Ψ of each modeling block associated with each vertex of the one or more vertices and each edge of the one or more edges according to the graph system.

Example 29. The method of example 11, wherein the set of control values is determined utilizing the optimization algorithm to identify the set of control values that optimize the optimization model.

Example 30. The method of example 29, wherein the set of control values is determined utilizing the optimization algorithm to identify the set of control values that optimize the optimization model in accordance with one or more constraints and one more cost elements associated with operation of an electrical system.

Example 31. The method of example 20, further comprising: providing a graphical user interface to a client computing device for a user to input the graph definition data.

Example 32. The method of example 31, wherein the graphical user interface provides a visual graphical representation of the graph system, including the one or more vertices and the one or more edges.

Example 33. The method of example 20, wherein each attribute is a characteristic of one or more of a vertex, an edge, and a graph layer, the characteristic being inherent to the associated modeling block, and wherein each attribute is one of an input attribute and output attribute, an input attribute representing a characteristic input to a modeling block and an output attribute representing a characteristic output from a modeling block, and wherein each output attribute is one of a diagnostic output attribute and a controllable output attribute.

Example 34. The method of example 33, wherein each input attribute is either static or able to be at least one of measured, forecasted, and calculated.

Example 35. The method of example 20, wherein the method is performed in a distributed computing paradigm, wherein constructing the optimization model is performed remote from determining the set of control values.

Example 36. The method of example 20, wherein the system comprises an electrical system.

Example 37. The method of example 20, wherein the system comprises a thermo-electrical system.

Example 38. A controller to control and/or to optimize operation of a physical system (e.g., an electrical system), comprising: a communication interface to connect to a communication path to a physical system to be controlled by the controller; a memory to store a multi-layer graph system or data structure that is a digital model or digital representation of a system, the system including the physical system to be controlled, the graph system comprising one or more graph layers each including one or more vertices and one or more intra-layer edges, each vertex of the one or more vertices representing an entity in the system and including on more attributes, each edge of the one or more edges representing a conduit of flow (e.g., transport) of an entity of the one or more attributes with respect to at least one entity in the system, wherein each graph layer, each vertex of the one or more vertices and each edge of the one or more edges is associated with a modeling block that describes a set of associated constraint expressions Ψ and a set of associated cost expressions Ω for the one or more attributes as pertaining to the associated vertex or edge; and one or processors to: construct an optimization model that includes one or more objective functions from the graph system, the optimization model constructed to include the set of associated cost expressions Ω and the set of associated constraint expressions Ψ (see example 43) of each modeling block associated with each graph layer of the one or more graph layers, each vertex of the one or more vertices and each edge of the one or more edges according to the graph system; and determine a set of control values for a set of controllable output attributes (e.g., control variables) of the one or more attributes, the set of control values to effectuate a change to the physical system for enhancing operation of the physical system, wherein the set of control values are determined by the one or more processors utilizing an optimization algorithm to identify the set of control values that optimize the optimization model in accordance with one or more constraints and one or more cost elements associated with operation of the electrical system; and provide the set of control values for the set of controllable output attributes (e.g., control variables) to the physical system, via the communication interface, to control operation of the physical system.

Example 39. The controller of example 38, wherein each graph layer supports one and only one flow of an attribute and each intra-layer edge represents the flow of the attribute with respect to at least one vertex (e.g., entity within the graph layer).

Example 40. The controller of example 39, wherein each graph layer of the one or more graph layers is associated with an objective and the overall objective is not a simple aggregation of all the cost expressions of all the modeling blocks.

Example 41. The controller of example 38, wherein the graph system further comprises one or more inter-layer edges extending between a first graph layer and a second graph layer of the one or more graph layers, each inter-layer edge of the one or more inter-layer edges representing a flow of the attribute identical to the flow attribute of one of the first graph layer and the second graph layer.

Example 42. The controller of example 41, wherein each graph layer is representative of a discrete system, wherein an inter-layer edge represents a relation between a first discrete system represented by the first graph layer and a second discrete system represented by the second graph layer, and wherein the physical system is one of the first discrete system and the second discrete system.

Example 43. The controller of example 38, wherein the optimization model is constructed to include the set of associated constraint expressions Ψ of each modeling block associated with each graph layer of the one or more graph layers, each vertex of the one or more vertices, and each edge of the one or more edges according to the graph system.

Example 44. The controller of example 38, wherein the set of control values are determined by the one or more processors utilizing the optimization algorithm to identify the set of control values that optimize the optimization model, and particularly that optimize the set of associated cost expressions Ω of each modeling block associated with each graph layer of the one or more graph layers, each vertex of the one or more vertices and each edge of the one of more edges, in accordance with the set of associated constraint expressions Ψ of each modeling block associated with each graph layer of the one or more graph layers, each vertex of the one or more vertices and each edge of the one or more edges.

Example 45. The controller of example 38, wherein the one or more processors are further to: receive graph definition data; generate the graph system in the memory based on the graph definition data.

Example 46. The controller of example 45, wherein the one or more processors are further to provide a graphical user interface for a user to input the graph definition data.

Example 47. The controller of example 46, wherein the graphical user interface provides a visual graphical representation of the graph system, including the one or more vertices and one or more edges.

Example 48. The controller of example 38, wherein each attribute is a characteristic of one or more of a vertex, and edge, and a graph layer, the characteristic being inherent to the associated modeling block, and wherein each attribute is one of an input attribute and an output attribute, an input attribute representing a characteristic input to a modeling block and an output attribute representing a characteristic output from a modeling block, and wherein each output attribute is one of a diagnostic output attribute and a controllable output attribute.

Example 49. The controller of example 48, wherein each input attribute is either static or able to be at least one of measured, forecasted, and calculated.

Example 50. The controller of example 38, wherein the one or more processors comprises a first processor to construct the optimization model from the graph system; and a second processor to determine the set of control values for the set of controllable output attributes.

Example 51. The controller of example 38, wherein the one or more processors comprises a plurality of processors each arranged remote from other of the plurality of processors in a distributed computing paradigm, wherein a first processor of the plurality of processors constructs the optimization model and a second processor of the plurality of processors determines the set of control values.

Example 52. The controller of example 38, wherein the physical system includes an electrical system, such that one graph layer of the one or more graph layers is representative of the electrical system.

Example 53. The controller of example 52, wherein the system further comprises a financial system such that another graph layer of the one or more graph layers is representative of the financial system, wherein an inter-layer edge extends between a vertex of the another graph layer representative of the financial system and a vertex of the one graph layer representative of the electrical system.

Example 54. The controller of example 52, wherein the physical system comprises a thermo-electrical system, such that one graph layer of the one or more graph layers is representative of the electrical system and another graph layer of the one or more graph layers is representative of the thermal system.

Example 55. The controller of example 38, wherein the system is the physical system.

Example 56. A method (e.g., of a controller) to control operation of a physical system (e.g., an electrical system), the method comprising: receiving graph definition data; generating a graph system based on the graph definition data, the graph system representing a system including a physical system to be controlled, the graph system comprising one or more graph layers each including one or more vertices and one or more intra-layer edges, each vertex of the one or more vertices representing an entity in the system and including one or more attributes, each intra-layer edge of the one or more intra-layer edges representing a flow of an attribute with respect to at least on entity in the system, wherein each vertex of the one or more vertices and each intra-layer edge of the one or more intra-layer edges is associated with a modeling block that describes a set of associated constraint expressions Ψ and a set of associated cost expressions Ω for the one or more attributes as pertaining to the associated vertex of edge; constructing an optimization model from the graph system, the optimization model including one or more objective functions and constructed to include the set of associated cost expressions Ω and the set of associated constraint expressions Ψ of each graph layer of the one or more graph layers, each modeling block associated with each vertex of the one or more vertices and each intra-layer edge of the one or more intra-layer edges according to the graph system; determine a set of control values for a set of controllable output attributes (e.g., control variables) of the one or more attributes, the set of control values to effectuate a change to the physical system for enhancing operation of the system, wherein the set of control values are determined utilizing an optimization algorithm to identify the set of control values that optimize the optimization model; and providing the set of control values for the set of controllable output attributes to one or more controllable elements of the physical system via a communication interface to control operation of the physical system.

Example 57. The method of example 56, wherein each graph layer supports one and only one flow of an attribute and each intra-layer edge represents the flow of the attribute with respect to at least one vertex (e.g., entity with the graph layer).

Example 58. The method of example 56, wherein each graph layer of the one or more graph layers is associated with an objective, and the overall objective is not a simple aggregation of all the cost expressions of all the modeling blocks.

Example 59. The method of example 56, wherein the graph system further comprises one or more inter-layer edges extending between a first graph layer and a second graph layer of the one or more graph layers, each inter-edge layer of the one or more inter-edge layers representing a flow of the attribute identical to the flow attribute of one of the first graph layer and the second graph layer; and the optimization model is potentially composed of multiple objectives which the controller must solve simultaneously (e.g., in a thermo-electrical system), the optimization model may be solved by maximizing comfort (as objective #1) while minimizing operating cost (as objective #2).

Example 60. The method of example 56, wherein the graph system further comprises one or more inter-layer edges extending between a first graph layer and a second graph layer of the one or more graph layers, each inter-layer edge of the one or more inter-layer edges representing a flow of the attribute identical to the flow attribute of one of the first graph layer and the second graph layer.

Example 61. The method of example 58, wherein each graph layer is representative of a discrete system, wherein an inter-layer edge represents a relation between a first discrete system represented by the first graph layer and a second discrete system represented by the second graph layer, and wherein the physical system is one of the first discrete system and the second discrete system.

Example 62. The method of example 56, wherein the optimization model is constructed to include or is otherwise subject to the set of associated constraint expressions Ψ of each modeling block associated with each graph layer of the one or more graph layers, each vertex of the one or more vertices, and each edge of the one more edges according to the graph system.

Example 63. The method of example 56, wherein the set of control values are determined utilizing the optimization algorithm to identify the set of control values that optimize the optimization model, and particularly that optimize the set of associated cost expressions Ω of each modeling block associated with each graph layer of the one or more graph layers, each vertex of the one or more vertices and each edge of the one or more edges, in accordance with the set of associated constraint expressions Ψ of each modeling block associated with graph layer of the one or more graph layers, each vertex of the one or more vertices and each edge of the one or more edges.

Example 64. The method of example 56, further comprising: providing a graphical user interface to a client computing device for a user to input the graph definition data.

Example 65. The method of example 64, wherein the graphical user interface presents a visual graphical representation of the graph system, including the one or more vertices and the one or more edges.

Example 66. The method of example 56, wherein each attribute is a characteristic of one or more of a vertex, an edge, and a graph layer, the characteristic being inherent to the associated modeling block, and wherein each attribute is one of an input attribute and an output attribute, an input attribute representing a characteristic to a modeling block and an output attribute representing a characteristic output from a modeling block, and wherein each output attribute is one of a diagnostic output attribute and a controllable output attribute.

Example 67. The method of example 66, wherein each input attribute is either static or able to at least one of measured, forecasted, and calculated.

Example 68. The method of example 56, performed in a distributed computing paradigm, wherein constructing the optimization model is performed remote from determining the set of control values.

Example 69. The method of example 56, wherein the physical system includes an electrical system, such that one graph layer of the one or more graph layers is representative of the electrical system.

Example 70. The method of example 69, wherein the system further comprises a financial system such that another graph layer of the one or more graph layers is representative of the financial system, wherein an inter-layer edge extends between a vertex of the another graph layer representative of the financial system and a vertex of the one graph layer representative of the electrical system.

Example 71. The method of example 56, wherein the physical system comprises a thermo-electrical system, such that one graph layer of the one or more graph layers is representative of the electrical system and another graph layer of the one or more graph layers is representative of the thermal system.

Example 72. The method of example 56, wherein the system is the physical system.

It will be obvious to those having skill in the art that many changes may be made to the details of the above-described embodiments without departing from the underlying principles of the invention. The scope of the present invention should, therefore, be determined only by the following claims.

1. A controller to control operation of a system, comprising:
a communication interface to connect to a communication path to one or more controllable elements of a system;
a memory to store a graph system comprising one or more vertices and one or more edges, each vertex of the one or more vertices representing an entity in the system that includes one or more attributes, each edge of the one or more edges representing a flow of an attribute with respect to at least one entity in the system, wherein each vertex of the one or more vertices and each edge of the one or more edges is associated with a modeling block that describes a set of associated constraint expressions Ψ and a set of associated cost expressions Ω for the one or more attributes; and
one or more processors to:
construct an optimization model from the graph system, the optimization model including one or more objective functions and constructed to include the set of associated cost expressions Ω of each modeling block associated with each vertex of the one or more vertices and each edge of the one or more edges according to the graph system;
determine a set of control values for a set of controllable output attributes of the one or more attributes, the set of control values to effectuate a change to the system for enhancing operation of the system, wherein the set of control values are determined by the one or more processors utilizing an optimization algorithm; and
provide the set of control values for the set of controllable output attributes to the system via the communication interface to control operation of the system.

2. The controller of claim 1, wherein the graph system further comprises one or more graph layers each comprising one or more of the one or more vertices and one or more intra-layer edges of the one or more edges,
wherein each graph layer supports one flow of an attribute;
wherein each graph layer is associated with a modeling block that describes a set of associated cost expressions Ω for the one or more attributes, and
wherein the one or more processors construct the optimization model from the graph system further to include the set of associated cost expressions Ω of each modeling block associated with each graph layer.

3. The controller of claim 2, wherein the graph system further comprises one or more inter-layer edges extending between a first graph layer and a second graph layer of the one or more graph layers, each inter-layer edge representing a flow of the attribute identical to the flow attribute of one of the first graph layer and the second graph layer.

4. The controller of claim 3, wherein the system is a complex system encompassing multiple discrete systems,
wherein each graph layer is representative of a discrete system of the multiple discrete systems,
wherein an inter-layer edge represents a relation between a first discrete system represented by the first graph layer and a second discrete system represented by the second graph layer, and
wherein the controllable elements of the system are included in one of the first discrete system and the second discrete system.

5. The controller of claim 1, wherein the optimization model is subject to the set of associated constraint expressions Ψ of each modeling block associated with each vertex of the one or more vertices and each edge of the one or more edges according to the graph system.

6. The controller of claim 1, wherein the set of control values are determined by the one or more processors utilizing the optimization algorithm to identify the set of control values that optimize the optimization model.

7. The controller of claim 1, wherein the one or more processors are further to: receive graph definition data; and
generate the graph system in the memory based on the graph definition data.

8. The controller of claim 1, wherein each attribute is a characteristic of one or more of a vertex, an edge, or a graph layer, the characteristic being inherent to the associated modeling block, and
wherein each attribute is one of an input attribute and an output attribute, an input attribute representing a characteristic input to a modeling block and an output attribute representing a characteristic output from a modeling block, and
wherein each output attribute is one of a diagnostic output attribute and a controllable output attribute.

9. The controller of claim 1, wherein the one or more processors comprise:
a first processor to construct the optimization model from the graph system; and
a second processor to determine the set of control values for the set of controllable output attributes.

10. The controller of claim 1, wherein the one or more processors comprises a plurality of processors each arranged remote from other of the plurality of processors in a distributed computing paradigm,
wherein a first processor of the plurality of processors constructs the optimization model and a second processor of the plurality of processors determines the set of control values.

11. A method to control operation of a system, the method comprising:
receiving graph definition data;
generating a graph system based on the graph definition data, the graph system comprising one or more vertices and one or more edges, each vertex of the one or more vertices representing an entity in the system that includes one or more attributes, each edge of the one or more edges representing a flow of an attribute with respect to at least one entity in the system, wherein each vertex of the one or more vertices and each edge of the one or more edges is associated with a modeling block that describes a set of associated constraint expressions Ψ and a set of associated cost expressions Ω for the one or more attributes;
constructing an optimization model from the graph system, the optimization model including one or more objective functions and constructed to include the set of associated cost expressions Ω and the set of associated constraint expressions Ψ of each modeling block associated with each vertex of the one or more vertices and each edge of the one or more edges according to the graph system;
determine a set of control values for a set of controllable output attributes of the one or more attributes, the set of control values to effectuate a change to the system for enhancing operation of the system, wherein the set of control values are determined utilizing an optimization algorithm to identify the set of control values that optimize the optimization model; and
providing the set of control values for the set of controllable output attributes to the system to control operation of the system.

12. The method of claim 11, wherein the graph system further comprises one or more graph layers each comprising one or more of the one or more vertices and one or more intra-layer edges of the one or more edges,
wherein each graph layer supports one flow of an attribute;
wherein each graph layer is associated with a modeling block that describes a set of associated cost expressions Ω for the one or more attributes and a set of associated constraint expressions Ψ, and
wherein constructing the optimization model from the graph system includes the set of associated cost expressions Ω of each modeling block associated with each graph layer.

13. The method of claim 12, wherein the graph system further comprises one or more inter-layer edges extending between a first graph layer and a second graph layer of the one or more graph layers, each inter-layer edge representing a flow of the attribute identical to the flow attribute of one of the first graph layer and the second graph layer.

14. The method of claim 13, wherein the system is a complex system encompassing multiple discrete systems,
wherein each graph layer is representative of a discrete system of the multiple discrete systems,
wherein an inter-layer edge represents a relation between a first discrete system represented by the first graph layer and a second discrete system represented by the second graph layer.

15. The method of claim 11, wherein the optimization model includes the set of associated constraint expressions Ψ of each modeling block associated with each vertex of the one or more vertices and each edge of the one or more edges according to the graph system.

16. The method of claim 11, wherein the set of control values are determined utilizing the optimization algorithm to identify the set of control values that optimize the optimization model.

17. The method of claim 11, further comprising:
providing a graphical user interface to a client computing device for a user to input the graph definition data.

18. The method of claim 11, wherein each attribute is a characteristic of one or more of a vertex, an edge, or a graph layer, the characteristic being inherent to the associated modeling block, and
wherein each attribute is one of an input attribute and an output attribute, an input attribute representing a characteristic input to a modeling block and an output attribute representing a characteristic output from a modeling block, and
wherein each output attribute is one of a diagnostic output attribute and a controllable output attribute.

19. The method of claim 11, performed in a distributed computing paradigm,
wherein constructing the optimization model is performed remote from determining the set of control values.

20. The method of claim 11, wherein the system comprises an electrical system.
